(19) United States
(12) Patent Application Publication
(10) Pub. No.: US 2020/0081103 A1
(43) Pub. Date: Mar. 12, 2020

(54) ANGULAR MAGNETIC FIELD SENSOR FOR A SCANNER

(71) Applicant: Blickfeld GmbH, Muenchen (DE)

(72) Inventor: Florian Petit, Muenchen (DE)

(21) Appl. No.: 16/496,852

(22) PCT Filed: Mar. 26, 2018
(86) PCT No.: PCT/DE2018/100275

§ 371 Date: Sep. 23, 2019

(30) Foreign Application Priority Data
Mar. 24, 2017 (DE) 10 2017 002 862.1

(51) Int. Cl. G01S 7/481; G01S 17/06; G01B 7/30; G02B 26/08; G02B 26/10

(52) U.S. Cl. CPC G01S 7/4817; G01S 17/06; G02B 26/101; G02B 26/0858; G01B 7/30

(57) ABSTRACT

A scanner (90) comprises a scanning unit (99, 99-1, 99-2) having an elastic element (101, 101-1, 101-2, 102, 102-1, 102-2), which extends between a base (141) and a deflection unit (142, 150), wherein the scanning unit (99, 99-1, 99-2) is set up to deflect light (180) at the deflection unit (142, 150) at different angles (901, 902) by means of torsion (502) of the elastic element (101, 101-1, 101-2, 102, 102-1, 102-2), a magnet (660) which is set up to generate a stray magnetic field, and an angular magnetic field sensor (662) which is arranged in the stray magnetic field and is set up to output a signal indicative of the torsion (502).

### TECHNICAL AREA

The various examples relate generally to a scanner for light. In particular, various examples relate to a scanner for laser light, which can be used, for example, for LIDAR measurements.

### BACKGROUND

The distance measurement of objects is desirable in various fields of technology. For example, it can be desirable in connection with applications of autonomous driving, detecting objects in the environment of vehicles, and particularly in determining a distance to objects.

One technique for the distance measurement of objects is the so-called LIDAR technology (known as light detection and ranging or sometimes also LADAR in English). In this process, pulsed laser light is emitted from an emitter. The objects in the environment reflect the laser light. These reflections can then be measured. By determining the travel time of the laser light, a distance to objects can be determined.

In order to detect the objects in the environment with spatial resolution, it may be possible to scan the laser light. Depending on the angle of radiation of the laser light, different objects in the environment can thereby be detected.

In various examples, it may be desirable to carry out a LIDAR measurement with particularly high resolution. In doing so, it may be desirable, for example, to record a two-dimensional (2D) environmental region within the scope of the LIDAR measurement. To this end, a 2D scanning region is implemented. In addition, it may be desirable to emit the laser light at well-defined angles. A lateral resolution of the LIDAR measurement, for example, is stipulated by means of such variables.

Reference implementations, for example, use multiple lasers spaced apart vertically in order to implement a 2D scanning region. Such techniques, however, are expensive and require significant installation space for the multiple lasers. In addition, a resolution along the direction of the multiple lasers is typically comparatively limited. Reference implementations, for example, have a resolution of between 4 and 64 bits in this direction.

In addition, with highly integrated reference implementations, it may oftentimes not be possible to monitor the angle of radiation of the laser light, or only possible to a limited extent. Therefore, a lateral resolution may be comparatively low. Temporal drifts can occur.

### BRIEF DESCRIPTION OF THE INVENTION

Therefore, there is a need for improved techniques regarding the scanning of light. In particular, there is a need for improved techniques in order to implement LIDAR measurements.

This object is achieved with the features of the independent claims. The features of the independent claims define embodiments.

A scanner comprises a first mirror. The first mirror comprises a reflecting front side and a back side. The scanner also comprises a first elastic suspension. The first elastic suspension extends to a side facing the back side of the first mirror, e.g. away from the back side of the first mirror. The scanner also comprises a second mirror. The second mirror comprises a reflecting front side and a back side. The scanner also comprises a second elastic suspension. The second elastic suspension extends to a side facing the back side of the second mirror, e.g. away from the back side of the second mirror. The scanner is set up to deflect light sequentially on the front side of the first mirror and on the front side of the second mirror,

Through the use of two mirrors, an optical path can be defined, which is sequentially reflected initially on the reflecting front side of the first mirror and subsequently on the reflecting front side of the second mirror. A 2D scanning region can thereby be implemented.

Sometimes, the at least one elastic suspension may also be characterized as an elastic support element or scanning module, because an elastic connection between a base—which defines a reference coordinate system in which, e.g., a light source may be arranged to emit the light—and a deflection unit is thereby provided; the deflection unit may characterize a moving coordinate system as compared to the reference coordinate system.

By virtue of the fact that the first elastic suspension and the second elastic suspension extend from the back side of the first mirror or of the second mirror, respectively, an especially high level of integration can be achieved for the scanner with both mirrors. Particularly in comparison to reference implementations in which suspensions are attached laterally in the mirror plane, it may be possible to arrange the first mirror and the second mirror especially close to one another. It may also thereby be achieved that an especially large detection aperture is achieved in relation to a detector by means of the first mirror and the second mirror. For example, the optical path may no longer strike the second mirror in the center when there is a significant scanning angle of the first mirror. The larger the distance between the mirrors, the greater this eccentricity. This reduces the detection aperture.

A scanner comprises at least one elastically moved scanning unit. This is set up to deflect light by means of a first degree of freedom of movement and a second degree of freedom of movement twice. The scanner also comprises at least one actuator. The scanner also comprises a controller, for example an FPGA, microcontroller, or ASIC. The controller is set up to actuate the at least one actuator in order to excite the first degree of freedom of movement according to a periodic amplitude modulation function. The amplitude modulation function has alternately arranged ascending flanks and descending flanks. A length of the ascending flanks, in this case, is at least double the size of a length of the descending flanks, optionally at least four times the size, further optionally at least 10 times the size. Alternatively, a length of the descending flanks, in this case, could also be at least double the size of a length of the ascending flanks, optionally at least four times the size, further optionally at least 10 times the size.

A scanner comprises at least one elastically moved scanning unit. This is set up to deflect light twice by means of a first degree of freedom of movement and a second degree of freedom of movement. The scanner also comprises at least one actuator. It is set up to excite the first degree of freedom of movement according to a periodic amplitude modulation function. The amplitude modulation function has alternately arranged ascending flanks and descending flanks.

Preferably in this case, a length of the ascending flank, in this case, is at least double the size of a length of the descending flanks, optionally at least four times the size, further optionally at least 10 times the size. Alternatively, a length of the descending flank, in this case, could also be at least double the size of a length of the ascending flanks, optionally at least four times the size, further optionally at least 10 times the size.

The elastic scanning unit is sometimes also characterized as the flexible scanning unit (flexure scan unit). The degree of freedom of movement can be provided by means of reversible deformation, i.e. elasticity. Typically, the degrees of freedom of movement are excited resonantly.

In some cases, the scanner could comprise, for example, two elastically moved scanning units. Each of the two elastically moved scanning units in this case could have a mirror with a reflecting front side and a back side, as well as one assigned elastic suspension each.

By means of such techniques, it is possible for a superposed figure of the movement according to the first degree of freedom of movement and the movement according to the second degree of freedom to be implemented in order to implement a 2D scanning region. In doing so, dead times during scanning can be reduced due to the especially short descending flanks. This enables the scanning of the 2D scanning region with high temporal resolution. This means that a repetition rate for multiple sequential LIDAR images can be particularly high.

A process comprises the actuation of at least one actuator. At least one actuator is set up to excite a first degree of freedom of movement of at least one elastically moved scanning unit according to a periodic amplitude modulation function. The periodic amplitude modulation function comprises alternately arranged ascending flanks and descending flanks. The at least one elastically moved scanning unit furthermore comprises a second degree of freedom of movement. The at least one elastically moved scanning unit deflects light twice by means of the first degree of freedom of movement and by means of the second degree of freedom of movement. A length of the ascending flanks is at least double the size of a length of the descending flanks, optionally at least four times the size, further optionally at least 10 times the size. Alternatively, it would also be possible that a length of the descending flanks is at least double the size of a length of the ascending flanks, optionally at least four times the size, further optionally at least 10 times the size.

A computer program product comprises program code, which can be executed by a controller. The execution of the program code means that the controller implements a process. A process comprises the actuation of at least one actuator. At least one actuator is set up to excite a first degree of freedom of movement of at least one elastically moved scanning unit according to a periodic amplitude modulation function. The periodic amplitude modulation function comprises alternately arranged ascending flanks and descending flanks. The at least one elastically moved scanning unit furthermore comprises a second degree of freedom of movement. The at least one elastically moved scanning unit deflects light twice by means of the first degree of freedom of movement and by means of the second degree of freedom of movement. A length of the ascending flanks is at least double the size of a length of the descending flanks, optionally at least four times the size, further optionally at least 10 times the size. Alternatively, it would also be possible that a length of the descending flanks is at least double the size of a length of the ascending flanks, optionally at least four times the size, further optionally at least 10 times the size.

A computer program comprises program code, which can be executed by a controller. The execution of the program code means that the controller implements a process. A process comprises the actuation of at least one actuator. At least one actuator is set up to excite a first degree of freedom of movement of at least one elastically moved scanning unit according to a periodic amplitude modulation function. The periodic amplitude modulation function comprises alternately arranged ascending flanks and descending flanks. The at least one elastically moved scanning unit furthermore comprises a second degree of freedom of movement. The at least one elastically moved scanning unit deflects light twice by means of the first degree of freedom of movement and by means of the second degree of freedom of movement. A length of the ascending flanks is at least double the size of a length of the descending flanks, optionally at least four times the size, further optionally at least 10 times the size. Alternatively, it would also be possible that a length of the descending flanks is at least double the size of a length of the ascending flanks, optionally at least four times the size, further optionally at least 10 times the size.

A scanner comprises a scanning unit having an elastic element. The elastic element extends between a base and a guiding element. The scanning unit in this case is set up to deflect light on the deflection unit at different angles by means of torsion of the elastic element. The scanner also comprises a magnet. It is set up to generate a stray magnetic field. The scanner also comprises an angular magnetic field sensor, which is arranged in the stray magnetic field. The angular magnetic field sensor is set up to output a signal, which is indicative of the torsion.

The torsion may correspond to a corresponding degree of freedom of movement of the elastic element. The torsion may also be provided by means of elastic deformation of the elastic element.

The combination of the magnet and the angular magnetic field sensor makes it possible to precisely monitor the rotation of the deflection unit based on the torsion. The angle, at which the light is deflected, can thereby be monitored precisely. The angle of radiation of the light can thereby be monitored precisely. The lateral resolution, for example of a LIDAR measurement, can thereby be increased. This can be particularly desirable in the scanner comprises two scanning units, each having a corresponding elastic element and a deflection unit, on which an optical path of the light is deflected sequentially. There may be increased imprecision in the angle of radiation there, namely without the corresponding monitoring.

The previously shown features and features to be described in the following may not only be used in the corresponding explicitly shown combinations but also in further combinations or in isolation, without going beyond the protective scope of the present invention.

### BRIEF DESCRIPTION OF THE FIGURES

FIG. 1 schematically illustrates a scanning unit according to various examples,

FIG. 2 schematically illustrates a scanning unit according to various examples.

FIG. 3 schematically illustrates a scanning unit according to various examples.

FIG. 4 schematically illustrates a scanning unit according to various examples.

FIG. 5 schematically illustrates actuators for exciting degrees of freedom of movement of the scanning units according to FIGS. 1-4.

FIG. 6 schematically illustrates actuators for exciting degrees of freedom of movement of the scanning units according to FIGS. 1-4.

FIG. 7 schematically illustrates actuators for exciting degrees of freedom of movement of the scanning units according to FIGS. 1-4.

FIG. 8 schematically illustrates the time curve of the movement of actuators of a pair of actuators to excite degrees of freedom of movement of the scanning units according to various examples.

FIG. 9 schematically illustrates the time curve of the movement of actuators of a pair of actuators to excite degrees of freedom of movement of the scanning units according to various examples.

FIG. 10 schematically illustrates the resonant excitation of one degree of freedom of movement according to various examples.

FIG. 11 schematically illustrates one degree of freedom of movement, which corresponds to various examples of a torsion of elastic elements.

FIGS. 12 and 13 schematically illustrate one degree of freedom of movement, which corresponds to various examples of a transverse deflection of elastic elements.

FIG. 14 schematically illustrates the superposed and resonant excitation of two degrees of freedom of movement according to various examples.

FIG. 15 schematically illustrates a scanning unit according to various examples.

FIG. 16 schematically illustrates a scanner with two scanning units according to various examples.

FIG. 17 schematically illustrates a scanner with two scanning units according to various examples.

FIG. 18 schematically illustrates a scanner with two scanning units according to various examples.

FIG. 19 schematically illustrates a scanner with two scanning units according to various examples.

FIG. 20 schematically illustrates a scanner with two scanning units according to various examples.

FIG. 21 schematically illustrates a scanner with two scanning units according to various examples.

FIG. 22 schematically illustrates a scanner with two scanning units according to various examples.

FIG. 23 schematically illustrates the time curve of an actuator movement, which is provided by means of actuators according to various examples for exciting degrees of freedom of movement of the scanning units.

FIG. 24 schematically illustrates the amplitude of movement according to one degree of freedom of movement, which is achieved by means of the time curve of the actuator movement according to the example in FIG. 23.

FIG. 25 schematically illustrates the time curve of an actuator movement, which is provided by means of actuators according to various examples for exciting degrees of freedom of movement of the scanning units.

FIG. 26 schematically illustrates the amplitude of movement according to one degree of freedom of movement, which is achieved by means of the time curve of the actuator movement according to the example in FIG. 25.

FIG. 27 schematically illustrates a superposed figure, which is implemented by means of a temporal superposition of movements according to the examples in FIGS. 24 and 26 by means of a scanner according to various examples.

FIG. 28 schematically illustrates a scanning unit with a magnet and an angular magnetic field sensor according to various examples.

FIG. 29A schematically illustrates an orientation of magnetization of the magnet according to the example in FIG. 28 upon torsion of an elastic element of the scanning unit.

FIG. 29B schematically illustrates an arrangement of the magnet in relation to the angular magnetic field sensor according to various examples.

FIG. 30 schematically illustrates a LIDAR system according to various examples.

FIG. 31 schematically illustrates a LIDAR system according to various examples.

FIG. 32 is a flowchart of an exemplary method.

### DETAILED DESCRIPTION OF EMBODIMENTS

The previously described properties, features, and advantages of this invention as well as the type and manner as to how they are achieved will become more clearly and noticeably understandable in the context of the following description of the exemplary embodiments, which are explained in greater detail in connection with the drawings.

In the following, the present invention is explained in greater detail by means of preferred embodiments, with reference to the drawings. The same reference numerals refer to equivalent or similar elements in the figures. The figures are schematic representations of various embodiments of the invention. Elements shown in the figures are not necessarily shown to scale. Rather, the various elements shown in the figures are reflected such that their function and general purpose will be understandable to one skilled in the art. Connections and couplings between functional units and elements shown in the figures can also be implemented as a direct connection or coupling. Functional units may be implemented as hardware, software, or a combination of hardware and software.

Various techniques for the scanning of light are described in the following. The subsequently described techniques can enable, for example, the 2D scanning of light. The scanning may characterize repeated emission of the light at different angles of radiation. To this end, the light may be deflected once or multiple times by means of a deflection unit.

The deflection unit, for example, may be formed by a mirror and optionally by an interface element, which affixes the mirror to an elastic element. The deflection unit may also comprise a prism instead of a mirror,

The scanning may characterize the repeated scanning of different points in the environment by means of the light. To this end, sequentially different angles of radiation can be implemented. The sequence of angles of radiation can be specified by means of a superposed figure when, e.g., two degrees of freedom of movement are temporally—and optionally spatially—superposed for scanning. For example, the quantity of different points in the environment and/or the quantity of different angles of radiation can stipulate a scanning region. In various examples, the scanning of light can occur by means of the temporal superposition and optionally a spatial superposition of two movements according to different agrees of freedom of at least one elastic suspension. A 2D scanning region is then obtained.

Sometimes, the superposed figure is characterized also as a Lissajous figure. The superposed figure may describe a sequence, with which different angles of radiation are implemented by means of the movement of the support element.

It is possible to scan laser light in various examples. In doing so, coherent or incoherent laser light, for example, can be used. It would also be possible to use polarized or unpolarized laser light. For example, it would be possible for the laser light to be pulsed. For example, short laser pulses with pulse widths in the range of femtoseconds or picoseconds or nanoseconds can be used. For example, a pulse duration can be in a range of 0.5-3 ns. The laser light may have a wavelength in a range of 700-1800 nm. For the sake of simplicity, reference is made primarily to laser light in the following; the various examples described herein, however, may also be used for scanning light from other light sources, for example broadband light sources or RGB light sources. In general, RGB light sources herein characterize light sources in the visible spectrum, wherein the color space is covered through the superposition of multiple different colors—for example, red, green, blue or cyan, magenta, yellow, black.

In various examples, at least one support element, which has a shape- and/or material-induced elasticity, is used to scan light. Therefore, the at least one support element could also be characterized as a spring element or elastic suspension. The support element has a moving end. At least one degree of freedom of movement of the at least one support element can then be excited, for example a torsion and/or a transverse suspension. In doing so, various orders of transverse modes can be excited. A deflection unit, which is connected to the moving end of the at least one support element, can be moved by means of such excitation of a movement. Therefore, the moving end of the at least one support element defines an interface element.

It would also be possible, for example, that more than one single support element is used, e.g. two or three or four support elements. They can be arranged symmetrically with reference to one another as an option.

In various examples, a moving end of a fiber or multiple fibers is used to scan the laser light; this means that the at least one support element can be formed by one or more fibers. Various fibers can be used as the support elements. For example, light fibers can be used, which are also characterized as glass fibers. In this case however, it is not necessary for the fibers to be produced from glass. The fibers can be produced, for example, from plastic, glass, or another material. For example, the fibers may be produced from quartz class. The fibers may have a length, for example, ranging from 3 mm to 10 mm, optionally ranging from 3.8 mm to 7.5 mm. For example, the fibers may have a 70 GPa modulus of elasticity. This means that the fibers may be elastic. For example, the fibers may enable up to 4% material expansion. In some examples, the fibers have a core, in which the supplied laser light propagates and is enclosed on the edges by means of total reflection (fiber-optic cable). However, the fibers do not have to have a core. In various examples, so-called single mode light fibers or multimode light fibers can be used. The various fibers described herein may have, for example, a circular cross-section. It would be possible, for example, that the various fibers described herein have a diameter which is no less than 50 μm, optionally no less than 150 μm, further optionally no less than 500 μm, further optionally no less than 1. For example, the various fibers described herein may be formed so as to bend or curve, i.e. be flexible or elastic. To this end, the material of the fibers described herein may have a certain elasticity. The fibers may have a core. The fibers may have a protective coating. In some examples, the protective coating may be at least partially removed, e.g. at the ends of the fibers.

In other examples, it would also be possible that elongated elements are produced from a wafer by means of MEMS techniques, i.e. by means of suitable lithography process steps, for example, by etching.

For example, the moving end of the support element could be moved in one or two dimensions—with a temporal and spatial superposition of two degrees of freedom of movement. To this end, one or more actuators may be used. For example, it would be possible that the moving end is tilted with respect to a securing of the at least one support element; this results in a curvature of the at least one support element. This can correspond to a first degree of freedom of movement; it can be characterized as a transverse mode (or sometimes also as a wiggle mode). Alternatively or in addition, it would be possible that the moving end is distorted along a longitudinal axis of the support element (torsion mode). This may correspond to a second degree of freedom of movement. The moving of the moving end makes it possible for laser light to be radiated at various angles. To this end, a deflection unit may be provided, such as, for example, a mirror optionally with a suitable interface for securement. An environment can thereby be scanned with the laser light. Depending on the strength of the movement of the moving end, differently sized scanning regions can be implemented.

In the various examples described herein, it is possible to excite the torsion mode as an alternative or in addition to the transverse mode, i.e. a temporal and spatial superposition of the torsion mode and the transverse mode would be possible. However, this temporal and spatial superposition can also be suppressed. In other examples, other degrees of freedom of movement could also be implemented.

For example, the deflection unit may comprise a prism or a mirror. For example, the mirror could be implemented by means of a wafer, for example a silicon wafer, or a glass substrate. For example, the mirror could have a thickness ranging from 0.05 μm to 0.1 mm. For example, the mirror could have a thickness of 25 μm or 50 μm. For example, the mirror could have a thickness ranging from 25 μm to 75 μm. For example, the mirror could be formed as a square, rectangle, or circle. For example, the mirror could have a diameter of from 3 mm to 12 mm or particularly 8 mm.

In general, such techniques can be used to scan light in the most varied of application areas. Examples comprise endoscopes and RGB projectors and printers and laser scanning microscopes. In various examples, LIDAR techniques can be used. The LIDAR techniques can be used to implement a distance measurement of objects in the environment with spatial resolution. For example, the LIDAR technique may comprise travel-time measurements of the laser light between the mirror, the object, and a detector. In general, such techniques can be used to scan light in the most varied of application areas. Examples comprise endoscopes and RGB projectors and printers. In various examples, LIDAR techniques can be used. The LIDAR techniques can be used to implement a distance measurement of objects in the environment with spatial resolution. For example, the LIDAR technique may comprise travel-time measurements of the laser light.

Various examples are based on the knowledge that it may be desirable to implement the scanning of the laser light with a high degree of accuracy with respect to the angle of radiation. For example, in connection with LIDAR techniques, a spatial resolution of the distance measurement can be limited by inaccuracy of the angle of radiation. Typically, a higher (lower) spatial resolution is achieved, the more precise (less precise) the angle of radiation of the laser light can be determined.

Various examples are further based on the knowledge that it may be desirable to implement the scanning of the laser light for a 2D scanning region. In doing so, it may often be desirable to implement the 2D scanning region by means of the temporal superposition of two degrees of freedom of movement and a corresponding superposed figure. The various examples described herein make it possible to implement a high-resolution, two-dimensional scanning region with great accuracy, wherein the corresponding scanner enables a comparatively large integration into a tight installation space.

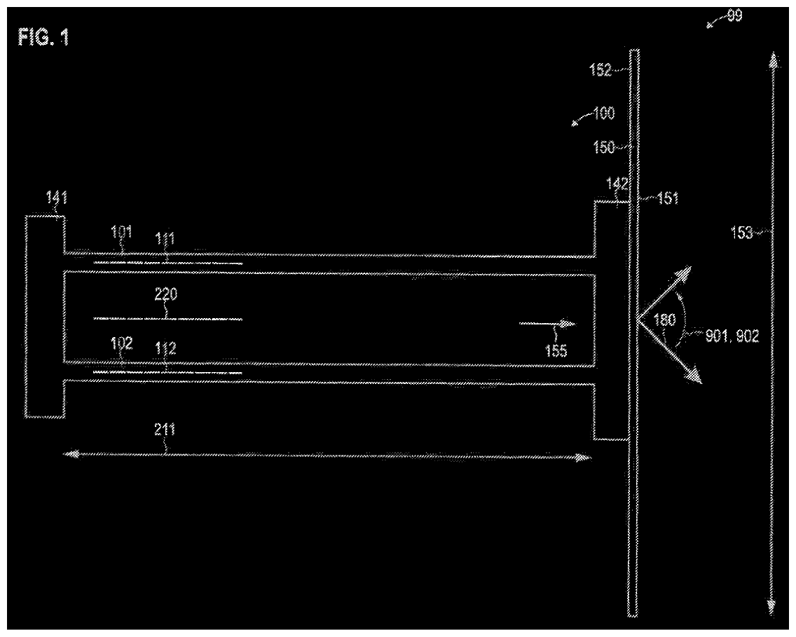

FIG. 1 illustrates aspects in relation to a scanning unit 99. The scanning unit 99 comprises a scanning module 100. The scanning module 100 comprises a base 141, two support elements 101, 102, as well as an interface element 142. The support elements 101, 102 are formed in a plane (drawing plane of FIG. 1). The scanning module 100 may also be characterized as an elastic suspension.

In this case, the base 141, the support elements 101, 102, as well as the interface element 142 are formed integrally. For example, it would be possible for the base 141, the support elements 101, 102, as well as the interface element 142 to be obtained through etching of a silicon wafer (or another semiconductor substrate) by means of MEMS processes. In such a case, the base 141, the support elements 101, 102, as well as the interface element 142 may be formed particularly to be monocrystalline. In other examples however, the base 141, the support elements 101, 102, as well as the interface element 142 may not be formed integrally; for example, the support elements could be implemented by means of fibers.

It would also be possible for the scanning module 100 to only have one single support element or more than two support elements.

The scanning unit 99 also comprises a mirror 150 implementing a deflection unit. In the example from FIG. 1, the mirror 150, which forms a mirror surface 151 for light 180 on the front side with high reflectivity (for example greater than 95% with a wavelength of 950 μm, optionally greater than 99%, further optionally greater than 99.999%; for example, aluminum or gold in a thickness of 80-250 nm), is not formed integrally with the base 141, the support elements 101, 102, as well as the interface element 142. For example, the mirror 150 could be bonded to the interface element 142. The interface element 142 may be set up, namely, to secure the mirror 150 and/or the mirror surface 151. For example, the interface element 142 may have a contact surface for this purpose, which is set up to secure a corresponding contact surface of the mirror 150. In order to connect the mirror 150 with the interface element 142, one or more of the following techniques, for example, could be used: bonding, soldering. The mirror also has a back side 152.

By means of such techniques, large mirror surfaces can be implemented, e.g. no less than 10 mm\hat{ }2, optionally no less than 15 mm\hat{ }2. In connection with LIDAR techniques, which use the mirror surface 151 also as a detector aperture, a high level of accuracy and range can be achieved.

In the example from FIG. 1, the scanning module 100 extends away from the back side 152 of the mirror 150, i.e. on a mirror 150 side facing the back side 152. A 1-point suspension of the mirror is thereby implemented.

In the example from FIG. 1, the support elements 101, 102 have an expansion perpendicular to the mirror surface 151; this expansion could be, e.g., about 2-8 mm, in the example from FIG. 1. The support elements 101, 102 are particularly rod-shaped along the corresponding longitudinal axes 111, 112. In FIG. 1, the surface normal 155 of the mirror surface 151 is shown; the longitudinal axes 111, 112 are oriented parallel to the surface normal 155, i.e. form an angle of 0° with it.

Therefore, the expansion of the support elements 101, 102, perpendicular to the mirror surface 151, is equal to the length 211 of the support elements 101, 102. In general, it would be possible that the length 211 of the support elements 101, 102 is no less than 2 mm, optionally no less than 4 mm, further optionally no less than 6 mm. For example, it would be possible that the length of the support elements 101, 102 is no greater than 20 mm, optionally no greater than 12 mm, further optionally no greater than 7 mm. If multiple support elements are used, they may all have the same length.

In general, the length 211 of the support elements 101, 102 could be in a range of 20%-400% of the diameter 153 of the mirror 150. In general, the length 211 could be no less than 20% of the diameter 153, optionally no less than 200% of the diameter, further optionally no less than 400%. On one hand, good stability can thereby be provided; on the other hand, comparatively large scanning regions can be implemented.

Depending on the relative orientation of the longitudinal axes 111, 112 in relation to the mirror surface 151, it would be possible, however, that the expansion of the support elements 101, 102, perpendicular to the mirror surface 151, is less than the length 211 thereof (because only the projection parallel to the surface normal 155 is considered). In general, it would be possible that the expansion of the support elements 101, 102, perpendicular to the mirror surface 151, is no less than 0.7 mm. Such a value is greater than the typical thickness of a wafer from which the scanning module 100 can be produced. An especially large scanning angle can thereby be implemented for the light 180.

The material of the support elements 101, 102 may affect a material-induced elasticity of the support elements 101, 102. Furthermore, the elongated, rod-like shape of the support elements 101, 102 may also affect a shape-induced elasticity of the support elements 101, 102. An elastic deformation to induce a movement of the interface element 142 and thus also of the mirror 150 can be achieved by means of such elasticity of the support elements 101, 102. For example, a torsion mode and/or a transverse mode of the support elements 101, 102 could be used to move the interface element 142—and thus the mirror 150. The scanning of light can thereby be implemented (FIG. 1 shows the standby state of the support elements 101, 102).

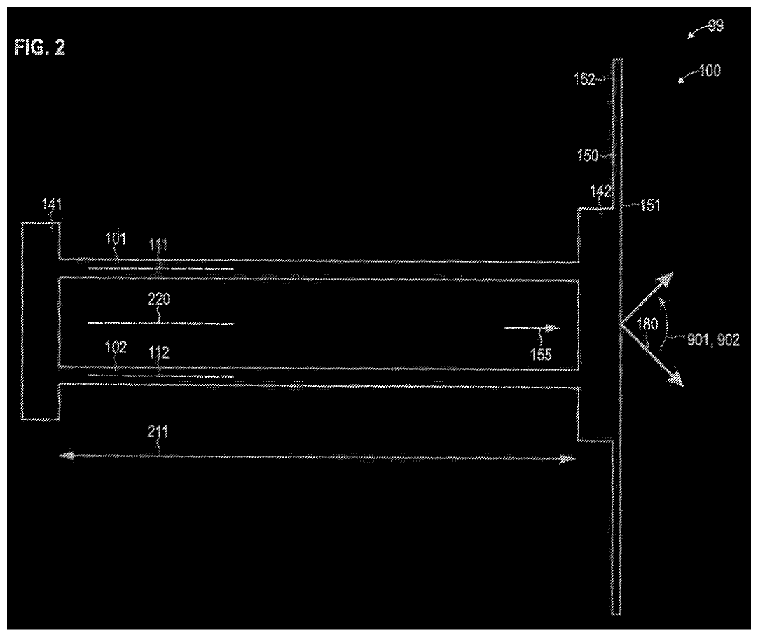

FIG. 2 illustrates aspects in relation to a scanning module 100. The scanning module 100 comprises a base 141, two support elements 101, 102, as well as an interface element 142. In this case, the base 141, the support elements 101, 102, as well as the interface element 142 are formed integrally.

The example from FIG. 2 essentially corresponds, in this case, to the example from FIG. 1. However, in the example from FIG. 2, the mirror 150 is formed with the interface element 142, or support elements 101, 102, as well as the base 141 integrally. In order to achieve the largest mirror surface 151 possible, the example from FIG. 2 indicates an overhang over the central region of the interface element 142.

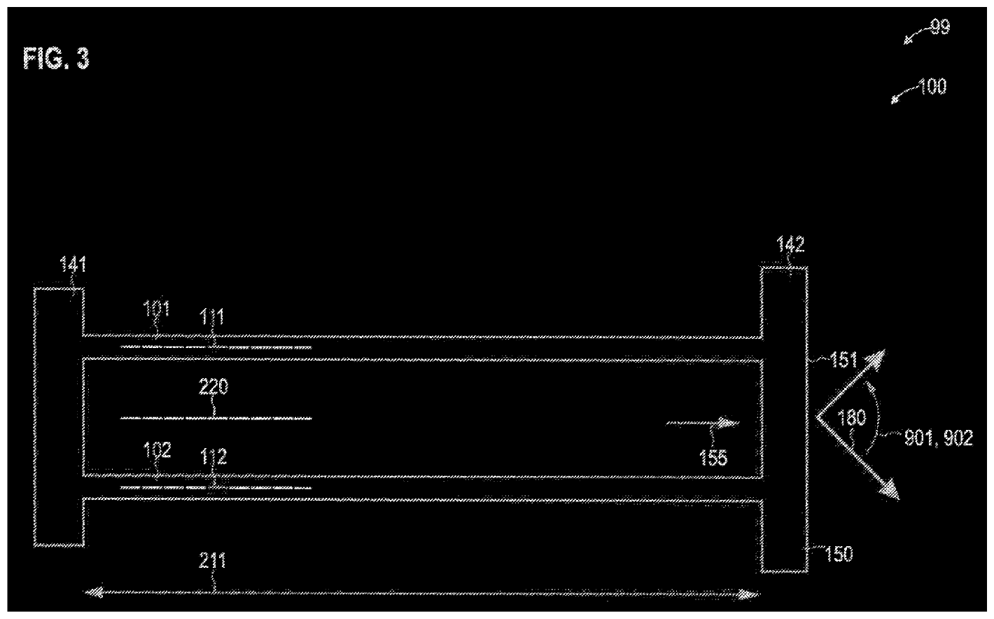

FIG. 3 illustrates aspects in relation to a scanning module 100. The scanning module 100 comprises a base 141, two support elements 101, 102, as well as an interface element 142. In this case, the base 141, the support elements 101, 102, as well as the interface element 142 are formed integrally.

The example from FIG. 3 essentially corresponds, in this case, to the example from FIG. 2. In the example from FIG. 3, the mirror 150 and interface element 142 are implemented by one and the same element. The mirror surface 151 implementing the deflection unit is directly applied to the interface element 142. This enables an especially simple construction and a simple production.

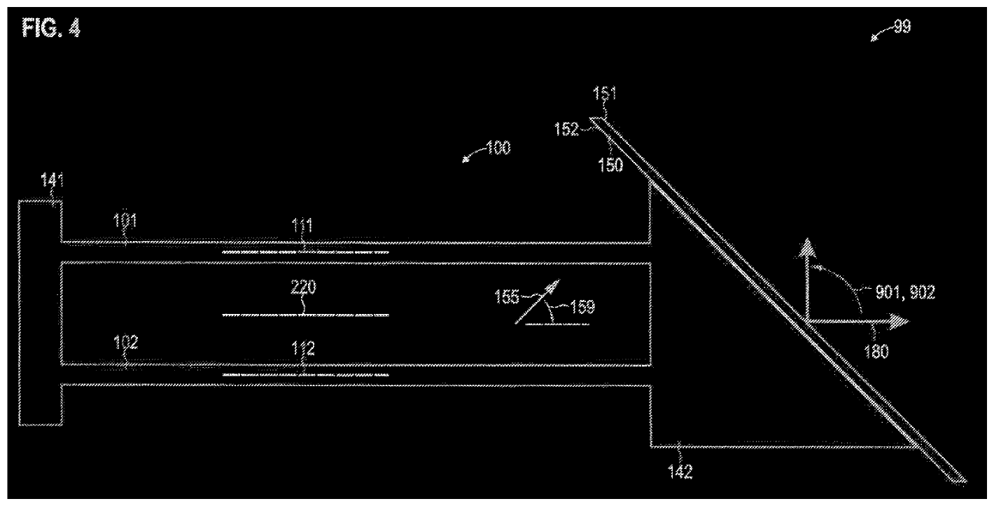

FIG. 4 illustrates aspects in relation to a scanning module 100. The scanning module 100 comprises a base 141, two support elements 101, 102, as well as an interface element 142. In this case, the base 141, the support elements 101, 102, as well as the interface element 142 are formed integrally.

The example from FIG. 4 essentially corresponds, in this case, to the example from FIG. 1. In the example from FIG. 4 however, the longitudinal axes 111, 112 of the support elements 101, 102 are not oriented perpendicular to the mirror surface 151. FIG. 4 shows the angle 159 between the surface normal 155 of the mirror surface 151 and the longitudinal axes 111, 112. In the example from FIG. 4, the angle 159 is 45°, but could generally be in a range of from −60° to +60°.

Such a tilting of the mirror surface 151 in relation to the longitudinal axes 111, 112 may be particularly advantageous when the torsion mode of the support elements 101, 102 is used to induce movement of the mirror 150. A periscope-like scanning of the light 180 can then be implement by means of the scanning unit 99.

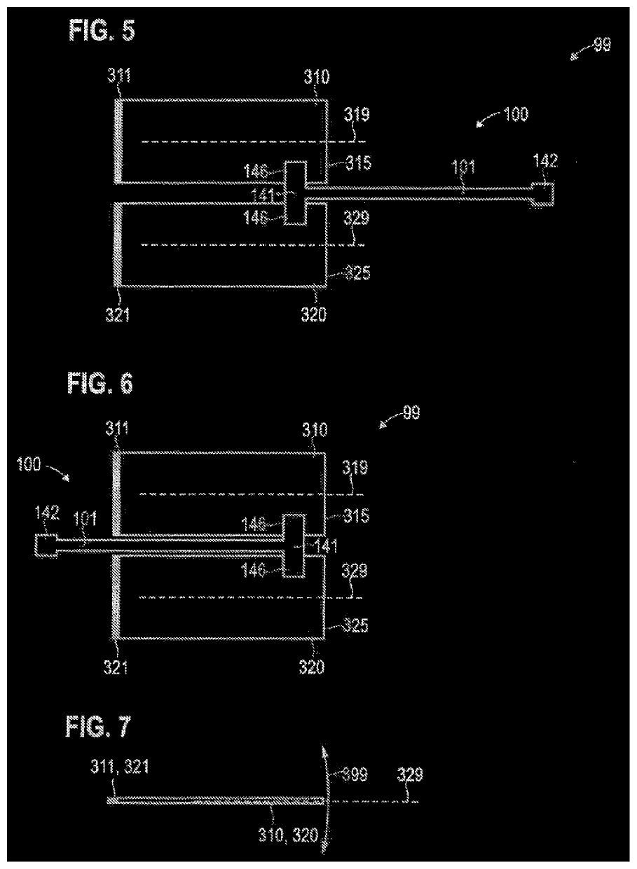

FIG. 5 illustrates aspects in relation to a scanning unit 99. The scanning unit 99 comprises the scanning module 100, which could be configured, for example, according to the various other examples described herein (however, FIG. 5A shows an example of a scanning module 100 with only one single support element 101).

FIG. 5 illustrates particular aspects in relation to piezo actuators 310, 320. In various examples, piezo bending actuators 310, 320 can be used to excite the support element 101. The piezo actuators 310, 320 can be actuated, e.g., by suitable controller—e.g. via a driver.

For example, generally a first and a second piezo bending actuator can be used. It would also be possible that the first piezo bending actuator and/or the second piezo bending actuator are formed in the shape of a disc. In general, a thickness of the piezo bending actuators, e.g., ranging from 200 μm to 1 mm, optionally ranging from 300 μm to 700 μm. It would be possible, for example, that the first piezo bending actuator and/or the second piezo bending actuator has a layer structure comprising an alternating arrangement of multiple piezoelectric materials. They may have a piezoelectric effect of varying strength. A bending can thereby be affected, similar to a bimetallic strip during temperature changes. For example, it is possible that the first piezo bending actuator and/or the second piezo bending actuator is secured at a fixation point; an end opposite the fixation point can then be moved based on a bending or curvature of the first piezo bending actuator and/or of the second piezo bending actuator.

And especially efficient and strong excitation can be achieved from the use of piezo bending actuators. The piezo bending actuators can move, namely, the base 141 and particularly tilt it—for excitation of a torsion mode of the at least one support element. In addition, it may be possible to achieve a high level of integration of the device for excitation. This may mean that the necessary installation space can be particularly small in size.

Particularly in the example from FIG. 5, the piezo actuators 310, 320 are formed as piezo bending actuators. This means that the application of a voltage at electric contacts of the piezo bending actuators 310, 320 effects a curvature or bending of the piezo bending actuators 310, 320 along the longitudinal axes 319, 329 thereof. To this end, the piezo bending actuators 310, 320 have a layer structure (not shown in FIG. 5 and oriented perpendicular to the drawing plane). An end 315, 325 of the piezo bending actuators 310, 320 is deflected with respect to a fixation point 311, 321 perpendicular to the respective longitudinal axes 319, 329 (the movement is oriented perpendicular to the drawing plane in the example from FIG. 5). The movement 399 of the piezo bending actuators 310, 320 (actuator movement) based on the bending is shown in FIG. 6.

FIG. 7 is a side view of he piezo bending actuators 310, 320. FIG. 7 shows the piezo bending actuators 310, 320 in a standby position of the scanning unit 99, for example without the driver signal and/or tension/curvature.

Again with reference to FIG. 5: For example, the fixation point 311, 321 could establish a rigid connection between the piezo bending actuators 310, 320 and a housing of the scanning unit 99 (not shown in FIG. 5) and be arranged stationary in a reference coordinate system.

The base 141 may have a longitudinal expansion of the longitudinal axes 319, 329, which is in a range of from 2-20% of the length of the piezo bending actuators 310, 320 along the longitudinal axes 319, 329, optionally in a range of from 5-15%. A sufficiently strong excitation can thereby be achieved; the base 141 then damps the movement of the piezo bending actuators 310, 320 only comparatively weakly.

In the example from FIG. 5, the piezo bending actuators 310, 320 are arranged substantially parallel to one another. Tilting of the longitudinal axes 319, 329 with respect to one another would also be possible, particularly as long as they are within one plane.

The example from FIG. 5 clearly shows that the connection of the piezo bending actuators 310, 320 with the support element 101 is implemented by means of the edge areas 146 of the base 141. Because these edge areas 146 have an elasticity, the bending 399 can be accommodated and leads to a deflection of the base 141. One or more degrees of freedom of movement of the interface element 101 can thereby be excited interconnectedly via the base 141. Especially efficient and space-saving excitation can thereby be achieved.

In the example from FIG. 5, the piezo bending actuators 310, 320 extend away from the interface element 142. It would also be possible that the piezo bending actuators 310, 320 extend toward the interface element 142 along at least 50% of their length. An especially compact arrangement can thereby be achieved. This is shown in FIG. 6.

The example from FIG. 6 essentially corresponds, in this case, to the example from FIG. 6. In this case however, the piezo bending actuators 310, 320 extend toward the interface element 142 or toward a freely moving end of the at least one support element 101. An especially compact structure of the scanning unit 99 can thereby be achieved,

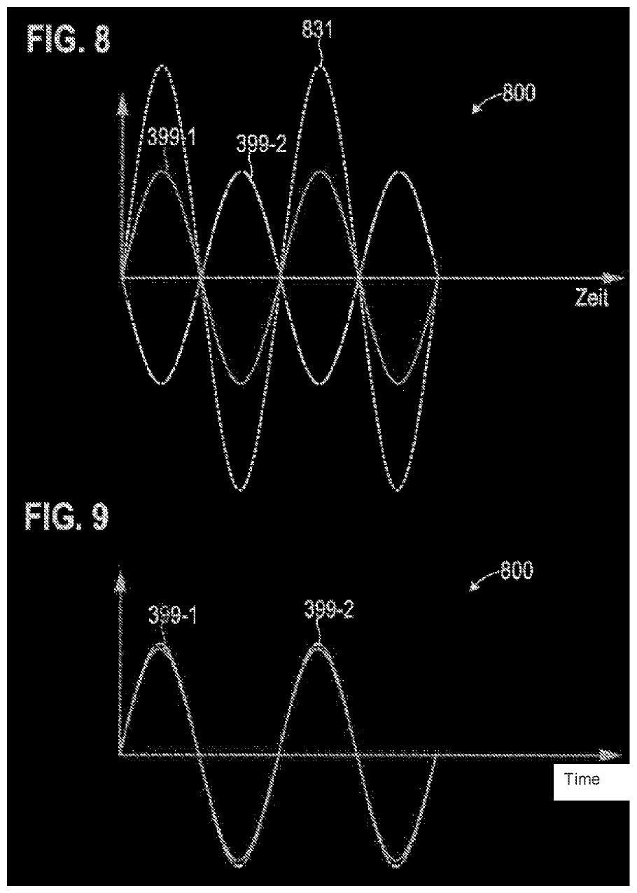

FIG. 8 schematically illustrates aspects in relation to a movement 399-1, 399-2 of the piezo bending actuators 310, 320. Due to a corresponding movement 399-1, 399-2, a force flow can be transferred to the support elements 101, 102 such that one or more degrees of freedom of movement can be excited.

In other examples, other types of actuators may be used. For example, actuators which transfer an excitation without contact could be used. A force flow corresponding to the movement 399-1, 399-2 can then also be implemented in another manner.

In the example from FIG. 8, a sinusoidal movement 399-1, 399-2 of the piezo bending actuators 310, 320 takes place, wherein there is a 180° phase shift between the movements 399-1, 399-2 (refer to the solid and dashed lines in FIG. 8). This results in a tilting of the base 141 (for example, in relation to the drawing plane in FIGS. 1-4), whereby a torsion mode can be excited especially efficiently.

FIG. 8 also shows the relative actuator movement 831 as a shift or distance in the direction of the movement 399-1, 399-2 between the ends 315, 325 of the piezo bending actuators 310, 320 based on the movements 399-1, 399-2 (dotted line in FIG. 8).

FIG. 9 schematically shows aspects in relation to a movement 399-1, 399-2 of the piezo bending actuators 310, 320. Due to a corresponding movement 390-1, 399-2, a force flow can be transferred to the support elements 101, 102 such that one or more degrees of freedom of movement can be excited.

The example from FIG. 9 essentially corresponds to the example from FIG. 8, wherein there is no phase shift between the movements 399-1, 399-2. This results in an up-and-down movement of the base 141 (for example in relation to the drawing plane in FIGS. 1-4), whereby a transverse mode can be excited especially efficiently.

In FIG. 9, the actuator movement 831 is equal to 0.

In some examples, it would also be possible that the movement of the piezo bending actuators 310, 320—or a differently formed force flow of a suitable actuator—excites a temporal and spatial superposition of multiple degrees of freedom of movement. This can take place, for example, by means of superposition of the movements 399-1, 399-2 according to the examples in FIGS. 8 and 9. Thus, a superposition of the movements 399-1, 399-2 in phase and out of phase can be used.

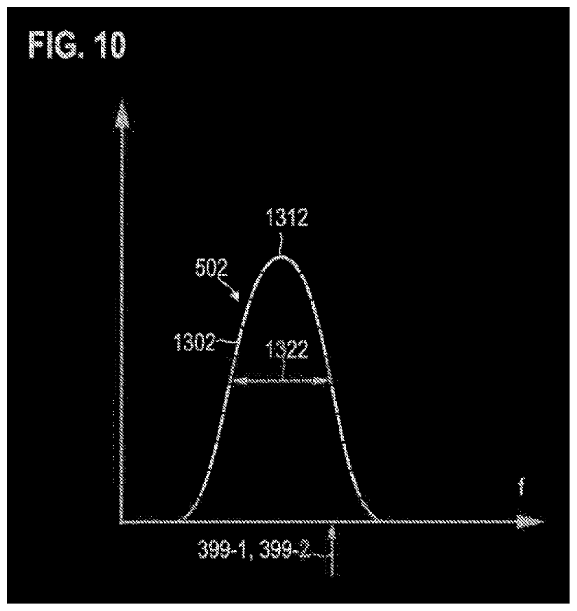

FIG. 10 schematically shows aspects in relation to a movement 399-1, 399-2 of the piezo bending actuators 310, 320. In particular, FIG. 10 illustrates the movement 399-1, 393-2 in the frequency domain. FIG. 10 illustrates a frequency of the movement 399-1, 399-2 in relation to a resonance curve 1302 of a torsion mode 502. The resonance curve 1302 is characterized by a full width at half maximum 1322 as well as a maximum 1312. In the example from FIG. 10, a resonant excitation takes place, because the frequency of the movement 399-1, 399-2 is arranged within the resonance curve 1302.

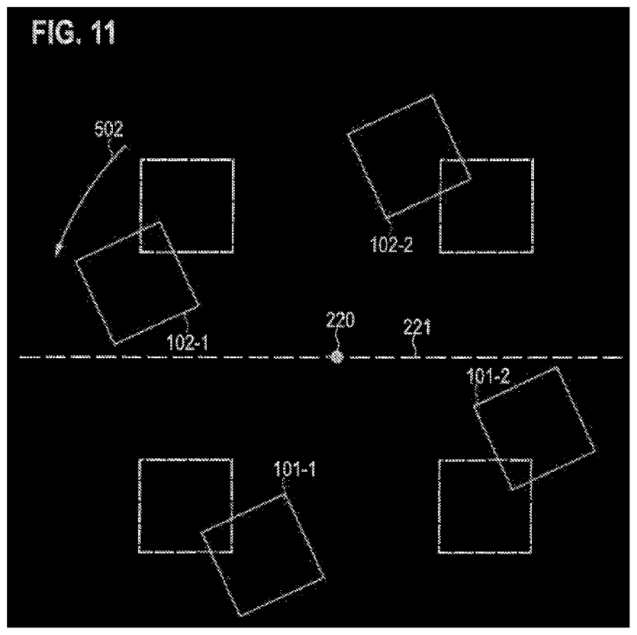

FIG. 11 illustrates aspects in relation to the torsion mode 502. FIG. 11 schematically illustrates the deflection of the torsion mode 502 for a scanning unit 99 with four support elements 101-1, 101-2, 102-1, 102-2 (FIG. 11 shows the deflected state with the solid lines and the standby state is shown with the dashed lines).

In FIG. 11, the torsion axis of the torsion mode 220 is congruent with the central axis 220. In the example from FIG. 11, the support elements 101-1, 102-1, 101-2, 102-2 are arranged with symmetrical rotation in relation to a central axis 220. In particular, a 4-fold rotational symmetry is present. The presence of rotational symmetry means, for example, that the system of support elements 101-1, 102-1, 101-2, 102-2 can transpose itself through rotation. The n order of the rotational symmetry characterizes how frequently the system of support elements 101-1, 102-1, 101-2, 102-2 can transpose itself per 360° angle of rotation. In general, the rotational symmetry may be n-fold, wherein n characterizes the number of support elements used.

Using the rotationally symmetrical arrangement with a high n order, the following effect can be achieved: Non-linearities during the excitation of the torsion mode 502 can be reduced or suppressed. The plausibility of this can be seen in the following example: for example, the support elements 101-1, 102-1, 101-2, 102-2 can be arranged such that the longitudinal axes and the central axis 220 are all in one plane. The rotational symmetry would then be 2-fold (and not 4-fold as in the example from FIG. 11). In one such case, the orthogonal transverse modes (different directions perpendicular to the central axis 220) have different frequencies—due to different moments of inertia. Thus, the direction of the low-frequency transverse mode, for example, rotates together with the rotation upon excitation of the torsion mode 502. A parametric oscillator is thereby formed because the natural frequencies vary as a function of the angle of rotation and/or thus as a function of time. The transfer of energy between the various states of the parametric oscillator causes non-linearities. The formation of the parametric oscillator can be prevented by using a rotational symmetry with a high n order. Preferably, the support elements may be arranged such that no natural-frequency dependency on the torsion angle occurs.

Because non-linearities can be avoided during the excitation of the torsion mode of the support elements 101-1, 102-1, 101-2, 102-2, it is possible that an especially large scanning angle of the light can be achieved by means of the torsion mode 502.

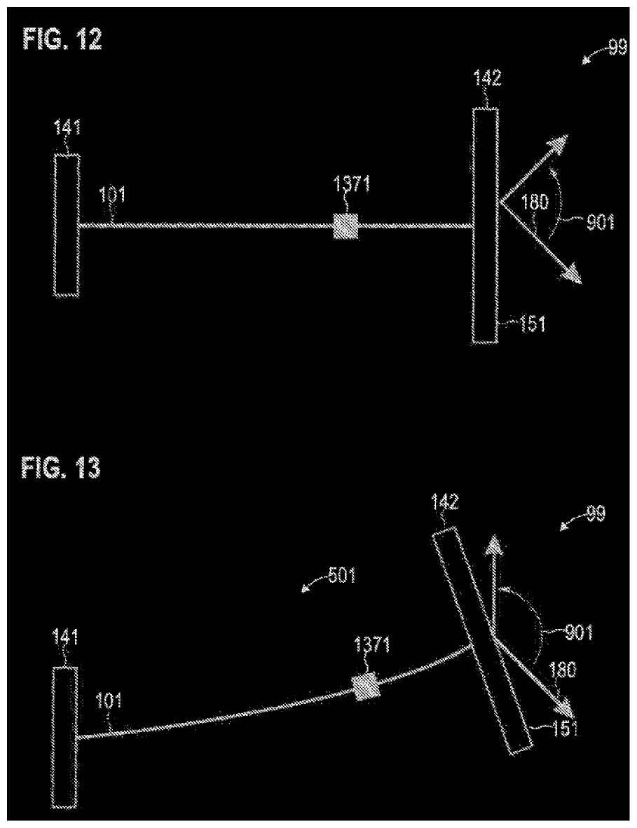

FIG. 12 illustrates aspects in relation to a scanning unit 99. In the example from FIG. 12, the scanning unit 99 comprises a single support element 101 with an optional balancing weight 1371. Therefore, tilting of the mirror surface 151 occurs during excitation of the transverse mode 501. This is shown in FIG. 13. FIG. 13 shows, in particular, the transverse mode 501 of the lowest order. In other examples, it would also be possible that a transverse mode of higher order is used for scanning light 180, wherein the deflection of the support element 101 would then be equal to zero at certain positions along the length 211 of the support element 101 (so called nodes or bulge of the deflection).

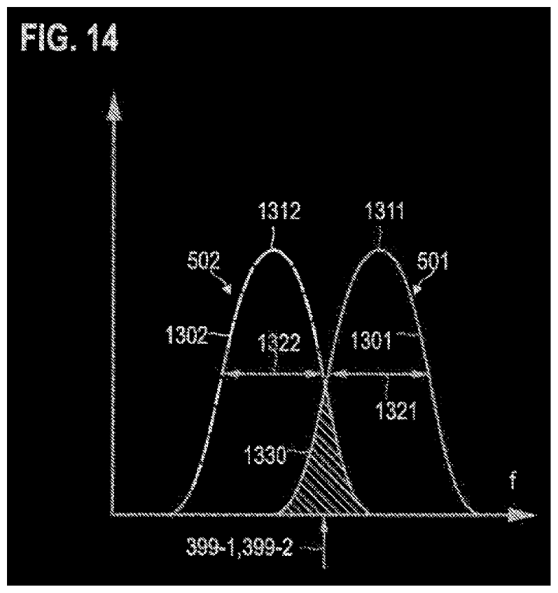

FIG. 14 illustrates aspects in relation to resonance curves 1301, 1302 of the degrees of freedom of movement 501, 502, by means of which, for example, a superposed figure can be implemented for a 2D scanning region. FIG. 14 here illustrates the amplitude of the excitation of the respective degree of freedom of movement 501, 502. A resonance spectrum according to the example in FIG. 14 may then be particularly desirable when a temporal and spatial superposition of the various degrees of freedom of movement 501, 502 of the at least one support element 101, 102 is desired for the 2D scanning.

In the example from FIG. 14, the two resonance curves 1301, 1302 could be excited temporally and spatially, e.g., in that a single scanning unit 99 is used to implement the various degrees of freedom of movement 501, 502. However, it would also be possible that, in the example from FIG. 14, the two resonance curves 1301, 1302 are excited with temporal superposition but not spatial superposition. To this end, it would be possible that a first scanning unit 99 is used in order to implement a degree of freedom of movement 501, 502 according to resonance curve 1301, and a second scanning unit 99 is used in order to implement the degree of freedom of movement 501, 502 according to resonance curve 1302.

The resonance curve 1301 of the transverse mode 501 has a maximum 1311 (solid line). FIG. 14 also shows resonance curve 1302 of the torsion mode 502 (dashed line). Resonance curve 1302 has a maximum 1312.

The maximum 1312 of the torsion mode 502 is at a lower frequency than the maximum 1311 of the transverse mode 501, which could be, e.g., the transverse mode 501 of the lowest order. It can thereby be achieved that the scanning module is particularly robust in relation to external interferences such as vibrations, etc. This is the case, because such external excitations typically excite the transverse mode 501 especially efficiently but do not excite the torsion mode 502 especially efficiently.

For example, the resonance curves 1301, 1302 could have a Lorentzian shape. This would be the case when the corresponding degrees of freedom of movement 501, 502 can be described by a harmonic oscillator.

The maxima 1311, 1312 are displaced against one another in frequency. For example, the frequency spacing between the maxima 1311, 1312 could be in a range of from 5 Hz to 500 Hz, optionally in a range of from 10 Hz to 200 Hz, further optionally in a range of from 30 Hz to 100 Hz.

FIG. 14 also shows the full widths at half maximum 1321, 1322 of the resonance curves 1301, 1302. Typically, the full width at half maximum is defined by damping of the corresponding degree of freedom of movement 501, 502. In the example from FIG. 14, the full widths at half maximum 1321, 1322 are equal; in general, the full widths at half maximum 1321, 1322, however, could be different from one another.

In the example from FIG. 14, the resonance curves 1301, 1302 have an area of overlap 1330 (indicated by shading). This means that the transverse mode 501 and the torsion mode 502 are degenerated. In the area of overlap 1330, both resonance curve 1301 and resonance curve 1302 have a significant amplitude. For example, it would be possible that the amplitudes of the resonance curves 1301, 1302 are no less than 10% of the corresponding amplitudes at the respective maximum 1311, 1312, optionally no less than 5%, further optionally no less than 1%, in the area of overlap. The area of overlap 1330 means that the two degrees of freedom of movement 501, 502 can be excited interconnectedly, namely resonantly at the same frequency. The frequency is between the two maxima 1311, 1312. The temporal and spatial superposition can thereby be achieved. On the other hand however, nonlinear effects can be suppressed or prevented by means of a coupling between the two degrees of freedom of movement 501, 502.

Instead of using different degrees of freedom of movement 501, 502—in the example from FIG. 14 of a torsion mode 502 and a transverse mode 501—a superposed figure could also be achieved by the double use of the same degree of freedom of movement. For example, the torsion mode 502 of a first scanning unit could be excited as well as the torsion mode 502 of a second scanning unit. In doing so, there is no spatial superposition of the two torsion modes, which may be assigned instead two different scanning units 99. As an alternative, it would also be possible, for example, to excite the transverse mode 501 of a first scanning unit as well as the transverse mode 501 of a second scanning unit. Even in such aforementioned cases of double use of the same degree of freedom of movement in different scanning units, a certain distance results between the maxima of the resonance curves, for example based on production tolerances or desired structural variation between the scanning units, etc.

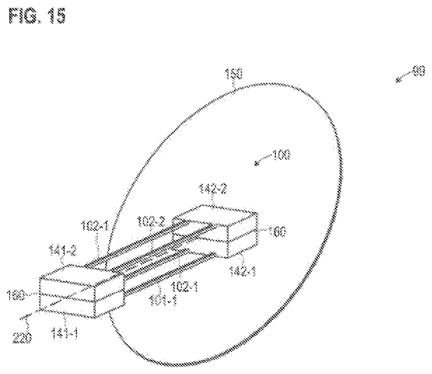

FIG. 15 illustrates aspects in relation to a scanning unit 99. In the example from FIG. 15, a scanning module 100 is shown, which has a first pair of support elements 101-1, 102-1 as well as a second pair of support elements 102-1, 102-2. The first pair of support elements 101-1, 102-1 is arranged in one plane; the second pair support elements 101-2, 102-2 is also arranged in one plane. These planes are parallel to one another and arranged offset with respect to one another.

In the example from FIG. 15, two scanning modules 100 can be combined, for example, according to the example from FIG. 4. Each pair of support elements in this case is assigned to a corresponding base 141-1, 141-2 as well as a corresponding interface element 142-1, 142-2. Both interface elements 142-1, 142-2 in this case produce a connection with a mirror 150. In this manner, it can be achieved that an especially stable scanning module 100 can be provided, which has a large number of support elements. In particular, the scanning module 100 may have support elements, which are arranged in different planes. This can enable an especially large amount of robustness.

FIG. 15 also clearly shows that base 141-1 is not formed integrally with base 141-2. In addition, interface element 142-1 is not formed integrally with interface element 142-2. Support elements 101-1, 102-1 are also not formed integrally with support elements 102-1, 102-2. In particular, it would be possible that the various aforementioned parts are produced from different areas of a wafer and subsequently connected to one another, for example, through bonding or anodic bonding. Other examples of connection techniques comprise the following: Fusion bonding, fusion and/or direct bonding, eutectic bonding, thermocompression bonding, and adhesive bonding. Corresponding connecting surfaces 160 are shown in FIG. 15. Such techniques mean that the scanning module 100 can be produced in an especially simple manner. In particular, it is not necessary for the complete scanning module 100 to be produced integrally or integrated from a wafer. Instead, the scanning module 100 can be produced in a two-stage production process. Simultaneously, this can reduce, however, the robustness insignificantly; based on the large-surface connecting surfaces 160, an especially stable connection can be produced between base 141-1 and base 141-2 and interface element 142-1 and interface element 142-2, respectively.

In this process however, it is possible that base 141-1, support elements 101-1, 102-1, as well as interface element 142-1 can be portrayed on base 141-2, support elements 102-1, 102-2, as well as interface element 142-2 through mirroring on a symmetrical plane (in which the connecting surfaces 160 are also present). A highly symmetrical configuration can thereby be achieved. In particular, a rotationally symmetrical configuration can be achieved. The rotational symmetry in this case may have an order of n=4; i.e. equal to the number of support elements 101-1, 101-2, 102-1, 102-2 used. Such a symmetrical configuration in relation to the central axis 220 may have particular advantages in relation to the excitation of torsion mode 502. Non-linearities can be avoided.

For example, a scanning unit 99 according to the example from FIG. 15 can be used for the torsion mode 502 according to the example from FIG. 11.

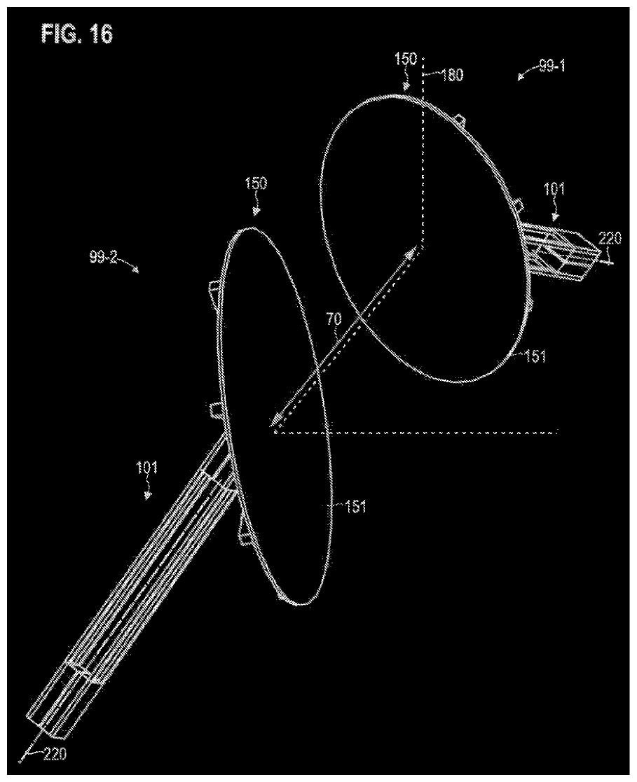

FIG. 16 illustrates aspects in relation to a scanner 90. The scanner 90 comprises two scanning units 99-1, 99-2, each of which is formed, for example, according to the example from FIG. 15. Thus, the scanner 90 is set up to sequentially deflect light 180 on the front sides of the mirrors 150 of the scanning units 99-1, 99-2 (the corresponding optical path is shown with a dotted line in FIG. 16). FIG. 16 illustrates the scanner in a standby state, i.e. without actuation of the scanning units 99-1, 99-2, for example, by means of the piezo bending actuators 310, 320.

For example, it would be possible that the torsion mode 502 of the two scanning modules 101 of the scanning units 99-1, 99-2 is excited in order to implement different angles of radiation according to the superposed figure, which defines a 2D scanning region. However, other degrees of freedom of movement could also be used.

FIG. 16 clearly shows that the suspensions of the mirrors 150 of the scanning units 99-1, 99-2 each comprise four elastic, rod-shaped elements 101-1, 101-2, 102-1, 102-2. Thus, the scanning units 99-1, 99-2 are configured according to the example from FIG. 15. In other examples however, it would also be possible that the suspensions of the mirrors 150 have fewer or more rod-shaped elements (for example, only one rod-shaped elastic element as shown in FIGS. 5 and 6, as well as 12 and 13).

In the example from FIG. 16, it is clear that the scanning modules 100 of the scanning units 99-1, 99-2 each extend away from the back sides of the mirrors 150 in different directions. Suspensions on the back side are implemented by the scanning modules 101. The scanning modules 101 extend to sides which are facing the back sides of the mirrors 150. In the mirror plane of the mirrors 150 of scanning units 99-1, 99-2, there are no suspensions. Due to such a one-point suspension on the back side of the mirror 150, it is possible that the mirrors 150 of the scanning units 99-1, 99-2 can be placed especially close to one another. Such a high level of integration of the scanner 90 enables a small housing design to be achieved. This facilitates the integration of the scanner 90, for example in personal vehicles or aerial drones, etc. In addition, it is possible that an effective detector aperture can be dimensioned especially large—if reflected light is also detected by means of the mirrors 150. This is thereby preferred, because significant shifting of the mirror edges occurs in reference implementations with large mirrors and large angles of deflection. Thus, it is possible that the mirrors make contact with suspensions in reference implementations, whereby the maximum aperture and/or angle is limited.

For example, FIG. 16 shows a distance 70 between a center of the mirror surface 151 of scanning unit 99-1 as well as of the mirror surface 151 of scanning unit 99-2. This distance 70 may be especially small. For example, this distance 70 can be no greater than four times the diameter of the mirror surface 151, optionally no greater than three times the diameter, further optionally no greater than 1.8 times the diameter.

In the example from FIG. 16, the central axis 220 of the scanning module 100 is tilted at an angle of 45° in relation to the surface normal 155 of the mirror surface 151 (cf. FIG. 4). Therefore, it may be desirable that a torsion mode 502 of both the scanning module 100 of scanning unit 99-1 as well as a torsion mode 502 of the scanning module 100 of scanning unit 99-2 are excited. They may be degenerated, wherein different resonance frequencies and/or maxima of the resonance curve are possible however.

In the example from FIG. 16, an angle between the central axes 220 of the scanning units 99-1, 99-2 is equal to 90°. This angle may also vary by 90°, for example amount to 90°±25°. An especially large scanning region can be implemented by means of such an arrangement.

For example, if transverse modes 501 are used for scanning light, it may then be desirable that the central axis 220 of scanning units 99-1, 99-2 form an angle of substantially 180° (not shown in FIG. 16), that is a linear arrangement of scanning units 99-1, 99-2 is selected (face-to-face).

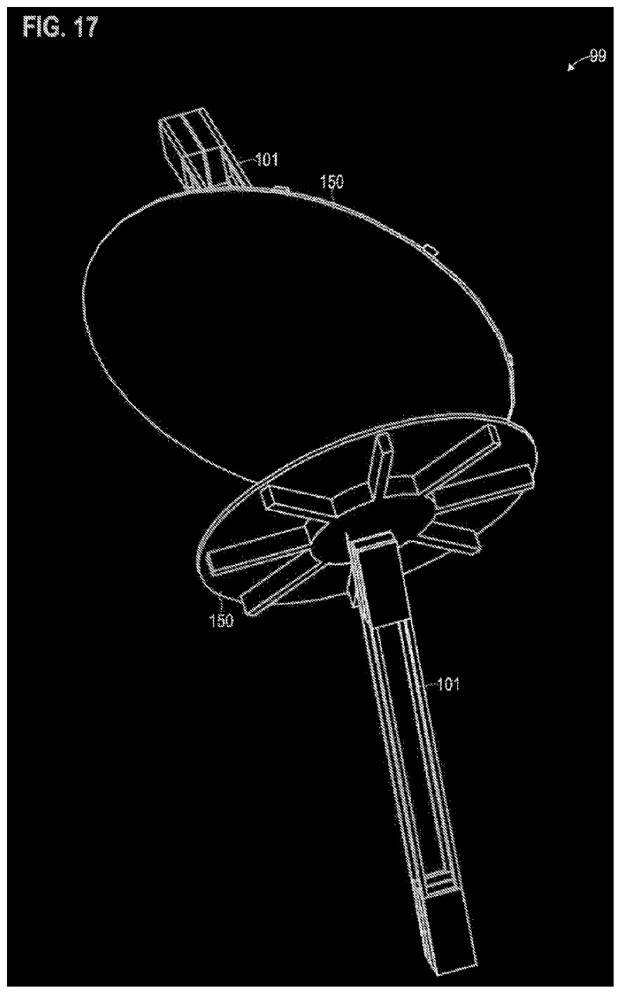

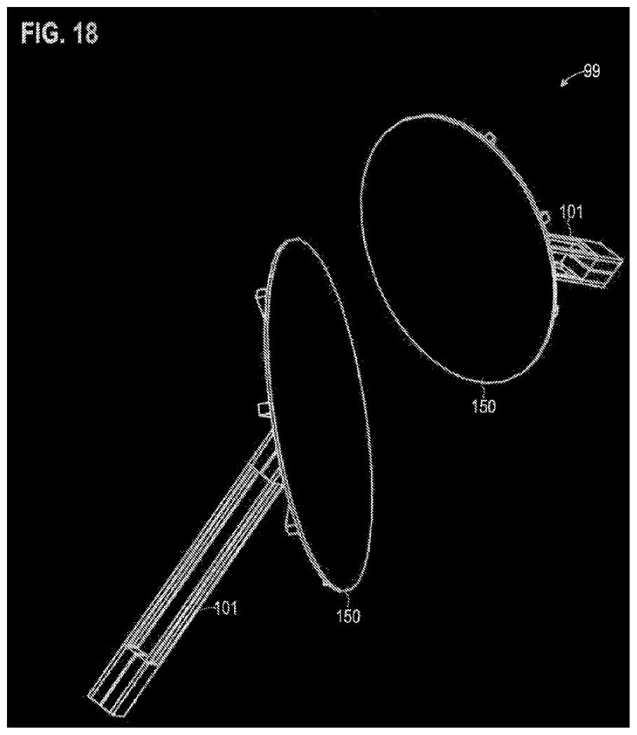

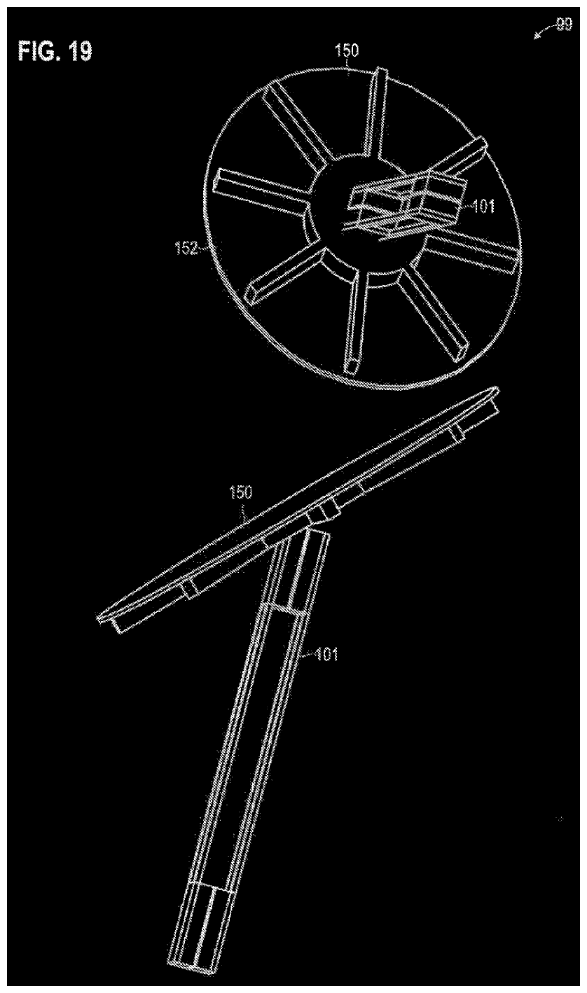

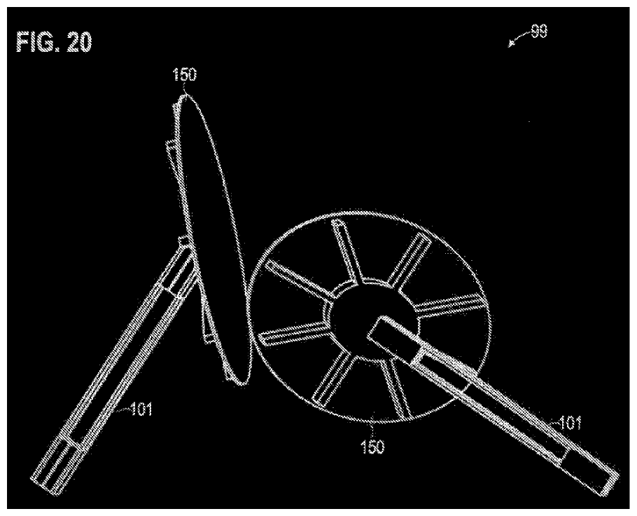

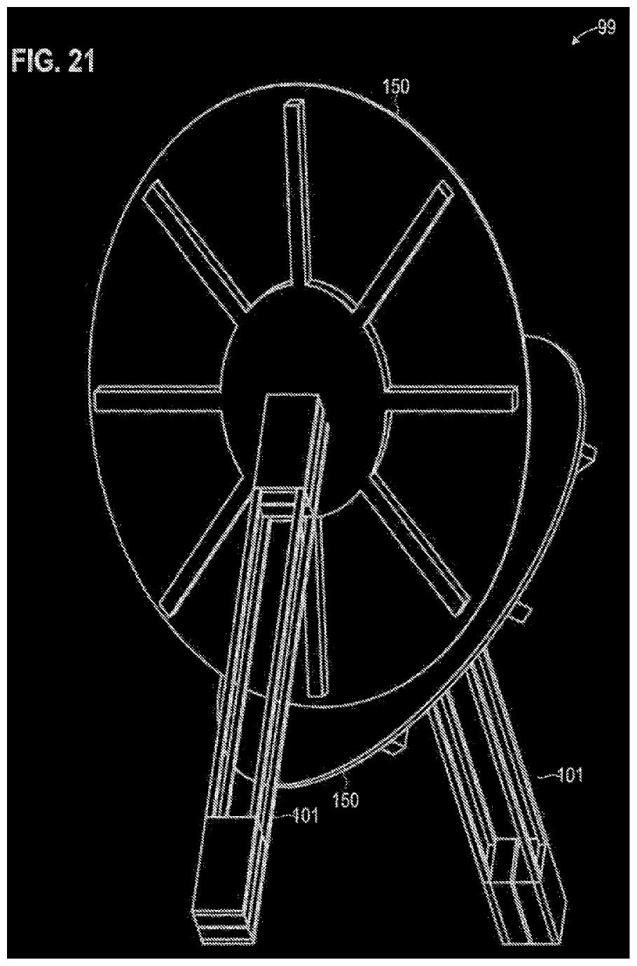

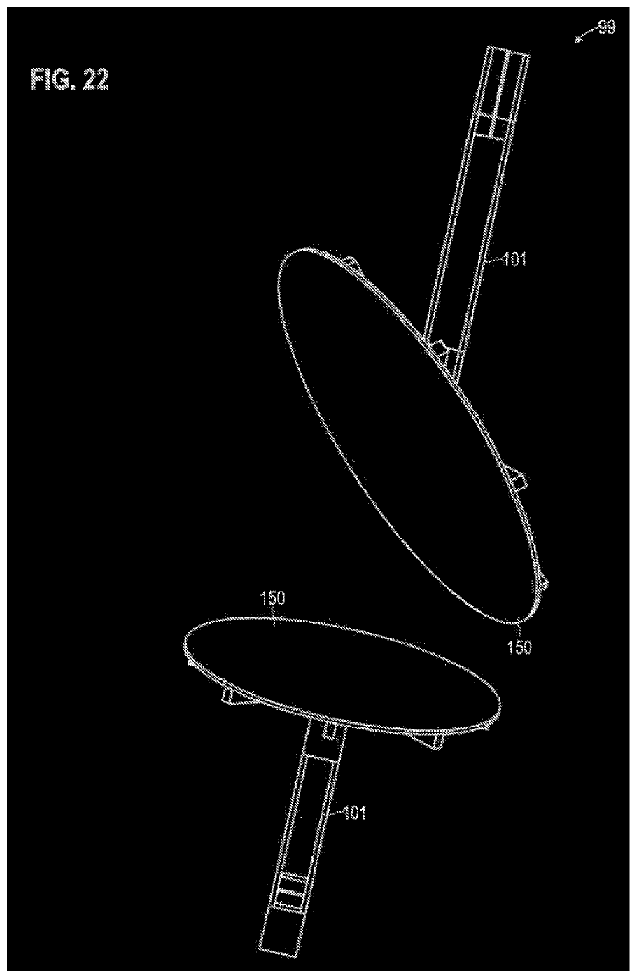

FIGS. 17-22 are different representations of the scanner 90 according to the example from FIG. 16. In this case, different perspectives are shown.

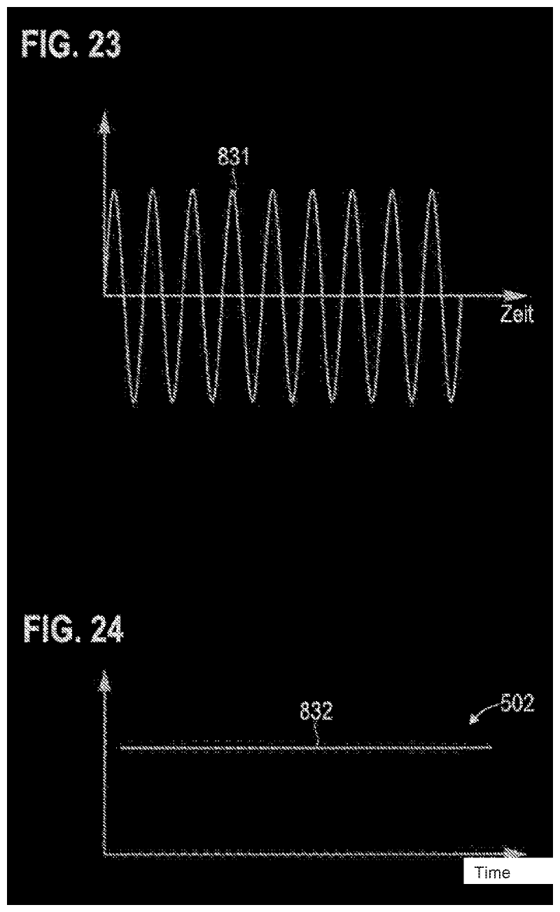

FIG. 23 illustrates aspects in relation to the actuation of a scanning module 100. For example, a scanning module 100 of the scanner 90 could be actuated correspondingly according to the examples from FIGS. 16-22.

FIG. 23 illustrates a time curve of the actuator movement 831. FIG. 23 shows particularly the relative deflection of the piezo bending actuators 310, 320 against one another as an actuator movement 831 (cf. FIG. 8). For example, FIG. 23 may illustrate thus a distance of the ends 315, 325 of the piezo bending actuators 310, 320 of the examples from FIGS. 5 and 6. However, other characteristics of the actuator movement 831 could also be considered—for example, movement 399-1 of piezo bending actuator 310 or movement 399-2 of piezo bending actuator 399-2. The actuator movement 831 is proportional to a force flow provided by the piezo bending actuators 310, 320. In this respect, FIG. 23 illustrates an example using piezo bending actuators 310, 320; in other examples however, other actuators, for example actuators which use magnetic fields, etc., could be used if a corresponding force flow is provided.

The frequency of the actuator movement 831 is matched to the resonance curve 1301, 1302 of the selected degree of freedom of movement 501, 502 (cf. FIGS. 10 and 14). A degree of freedom of movement 501, 502 is excited by means of the actuator movement. In the example from FIG. 24, the torsion mode 502 is excited, because the actuator movement 831 effects a tilting of the base 141 of the scanning module 100. This is the case, because the actuator movement 831 effects a time-variable distance between the ends 315, 325 of the piezo bending actuators 310, 320. In other examples, the transverse mode 501 could also be excited by means of a suitable actuator movement.

In the example from FIG. 23, the actuator movement 831 has a constant amplitude. The torsion mode 502 is thereby excited with constant amplitude 832. This is shown in FIG. 24 (FIG. 24 does not show the instantaneous deflection of the torsion mode).

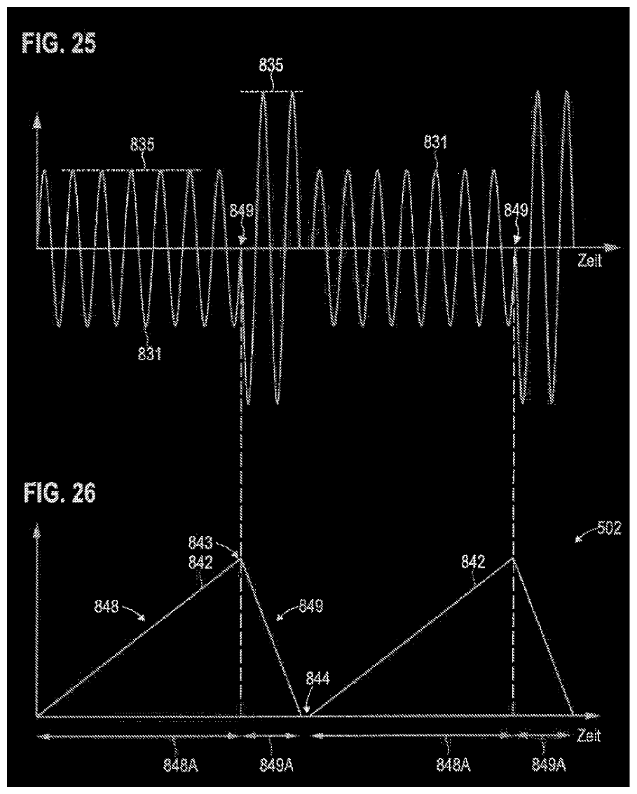

FIGS. 25 and 26 substantially correspond to FIGS. 23 and 24. In the example from FIGS. 25 and 26, the piezo bending actuators 310, 320 are set up, however, in order to excite the torsion mode 502 according to a periodic amplitude modulation function 842, which has alternating ascending flanks 848 and descending flanks 849. To this end, a suitable actuator movement 831 is implemented.

FIG. 26 particularly shows that the length 848A of the ascending flanks 848 is substantially greater than the length 849A of the descending flanks 849. For example, the length of the ascending flanks 848 could be at least double the size of a length of the descending flanks 849, optionally at least four times the size, further optionally at least 10 times the size.

In the example from FIG. 25, the descending flanks 849 are short enough such that their lengths are no greater than two time periods of the frequency of the resonantly actuated torsion mode 502 and/or the frequency of the actuator movement 831. In general, the length of the descending flanks 849 of the amplitude modulation function 842 can be no greater than 10 time periods of the frequency of the torsion mode 502, optionally no greater than three time periods, further optionally no greater than two time periods.

Especially short dimensioning of the length 849A of the descending flanks 849 can make it possible for the scanning module 100 to be transitioned especially quickly into the standby state 844 in relation to the corresponding degree of freedom of movement 501, 502, after completed actuation of up to the maximum amplitude 843—upon which there can be another actuation. This means that a reset of the movement can quickly take place according to the corresponding degree of freedom of movement 501, 502. This can be particularly helpful when a superposed figure is implemented by means of the corresponding degree of freedom of movement.

For example, it would be possible that LIDAR measurements are carried out for imaging only during the ascending flanks 848. The quantity of all LIDAR measurements taken during the time period 848A may correspond, in this case, to a LIDAR image for a particular environmental region. The same environmental region can be scanned again after the reset such that LIDAR images are provided with a certain image-repetition frequency. The shorter the length 849A, the higher the image-repetition frequency.

The short dimensioning of the length of the descending flanks 849 can be achieved by means of a slowing of the movement according to the torsion mode 502 during the descending flanks 849. In other words, this means that the movement according to the torsion mode 502 is actively damped, i,e, is more strongly damped than is provided by intrinsic damping and/or the mass moment. To this end, a suitable actuator movement 831 of the piezo bending actuators 310, 320 is used.

Such a slowing of the movement of the torsion mode 502 is achieved particularly by means of an increase in the amplitude 835 of the actuator movement 831 during the descending flanks 849. This can be achieved, for example, by means of increasing the individual movements 399-1, 399-2 of the piezo bending actuators 310, 320. For example, a mean amplitude of the actuator movement 831 during the descending flanks 849 could be double the size of a mean amplitude of the actuator movement 831 during the ascending flanks 848, optionally at least four times the size, further optionally at least 10 times the size. Due to the increasing of amplitude of the actuator movement 831 during the descending flanks 849, an especially quick slowing of the movement according to the torsion mode 502 can be achieved. This is the case, because the flow of force onto the scanning module 100 can be increased.

The slowing of the movement of the torsion mode 502 can also be achieved by means of a phase jump 849 in the actuator movement 831. This can be achieved, in turn, by means of a phase jump in the individual movements 399-1, 399-2 of the piezo bending actuators 310, 320. In the example from FIG. 25, the phase jump 849 implements a phase shift in the deflection of each of the two piezo bending actuators 310, 320. For example, individual movement 399-1 of piezo bending actuator 310 has a phase shift of 180° between the ascending flank 848 and the descending flank 849. Correspondingly, individual movement 399-2 of piezo bending actuator 320 also has a phase shift of 180° between the ascending flank 848 and the descending flank 849. The phase jump 849 in the resulting actuator movement 831 shown in FIG. 25 is thereby achieved as a distance between the ends 315, 325. An opposite-phase excitation of the torsion mode 502 is also thereby achieved in the timeframe of the descending flank 849 as compared to the timeframe of the ascending flank 848, which results in the slowing of the movement according to the torsion mode 502 during the descending flanks 849.

While in the example from FIG. 25, the actuator movement 831 has a constant amplitude 835 during the ascending flanks 848, and a constant amplitude 835 during the descending flanks 849, it would also be possible in other examples that the actuator movement 831 has a time-variable amplitude during the ascending flanks 848 and/or a time-variable amplitude during the descending flanks 849 (not shown in FIG. 25).

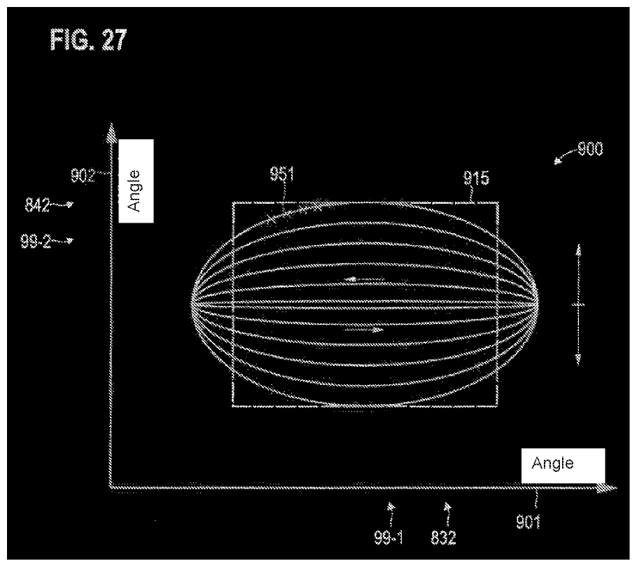

In some examples, a first scanning unit 99-1 of a scanner 90 could be operated according to the examples in FIGS. 23 and 24, and a second scanning unit 99-2 of a scanner 90 could be operated according to the examples in FIGS. 25 and 26. In other words, this means that differently actuated degrees of freedom of movement—for example to torsion modes 502 or two transverse modes 501—may be associated with different scanning units 99-1, 99-2. A superposed figure enabling a two-dimensional scanning region can be obtained therefrom. This is shown in FIG. 27.

FIG. 27 illustrates aspects in relation to a superposed FIG. 900. FIG. 27 illustrates particular aspects in relation to a 2D scanning region 915 (dashed line in FIG. 27), which is defined by the superposed FIG. 900. FIG. 27 in this case shows the scanning angle 901 which can be achieved by means of the torsion mode 502 actuated with constant amplitude 832 (cf. FIGS. 23 and 24), e.g. by means of the scanning unit 99-1. FIG. 27 in this case shows the scanning angle 902 which can be achieved by means of the torsion mode 502 actuated with constant amplitude 842 (cf. FIGS. 25 and 26), e,g, by means of the scanning unit 99-2. Through the use of the two scanning angles 901, 902, an angle of radiation can be obtained which varies in two orthogonal spatial directions, whereby a 2D environmental region can be scanned.

In other examples however, a transverse mode 501 with constant amplitude and a transverse mode 501 with modulated amplitude could be used. In yet other examples, a transverse mode 501 and a torsion mode 502 could be used. It would also be possible to use transverse modes 501 of a different order. It would also be possible to use torsion modes 502 of a different order.

The superposed FIG. 900 according to the example from FIG. 27 is obtained when the torsion modes 502 of the scanning units 99-1, 99-2 have the same frequency. Nodes in the superposed FIG. 900—as they otherwise typically occur for Lissajous scanning—are prevented. In addition, the superposed FIG. 900 according to the example from FIG. 27 is then obtained when the amplitude of the torsion mode is increased during the ascending flanks 848 of the amplitude modulation function 842. This means, namely, that the superposed FIG. 900 is obtained as a sort of “opening eye”; i.e., larger scanning angles 901 are obtained as the amplitude of the transverse mode 501 increases (indicated by the vertical, dotted arrow in FIG. 27). Scan lines can thereby be obtained (horizontal dotted arrow in FIG. 27), with which the environment of the laser scanner 99 can be scanned. Different pixels 951 can then be obtained through repeated emission of light pulses. Superimposed figures with a lot of nodes can be prevented, whereby an especially great image-repetition frequency can be achieved. In addition, this prevents certain regions between the nodes from not being scanned.

Due to the quick slowing during the descending flanks 849, the “opening eye” can be quickly repeated, i.e. the superposed FIG. 900 can be implemented quickly one after the other. Dead times are reduced.

Previously, techniques were explained in which an “opening eye” is used, i.e. a reset of the superposed FIG. 900 is implemented by means of the descending flanks 849. In other examples, a “closing eye” could also be used. The descending flanks 849 may have a length 849A there which is greater than the length 848A of the ascending flanks 848. The LIDAR imaging can then primarily or exclusively take place during the descending flanks 849.

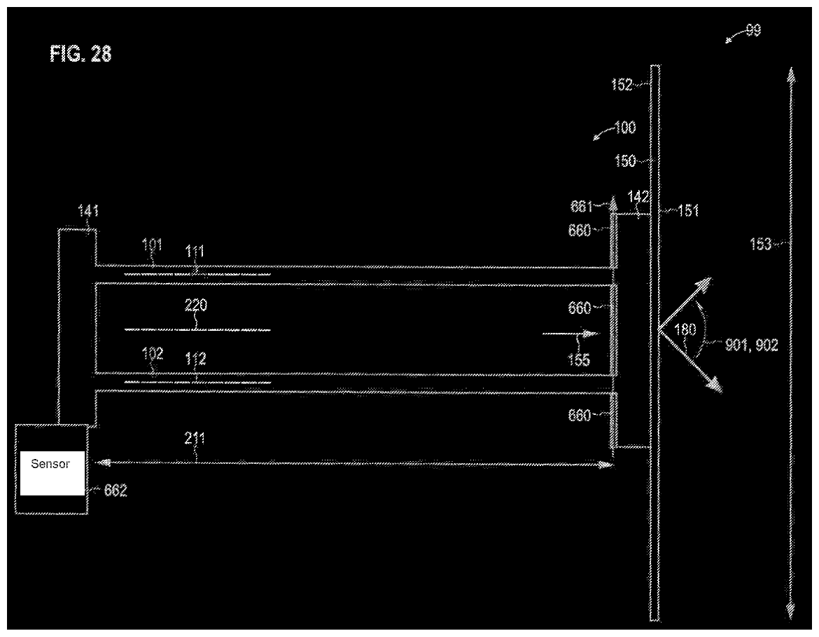

In the various examples described herein, it may be desirable to determine particularly well the scanning angle 901, 902 of the scanning units 99, 99-1, 99-2 used. To this end, techniques according to the example in FIG. 28 can be used.

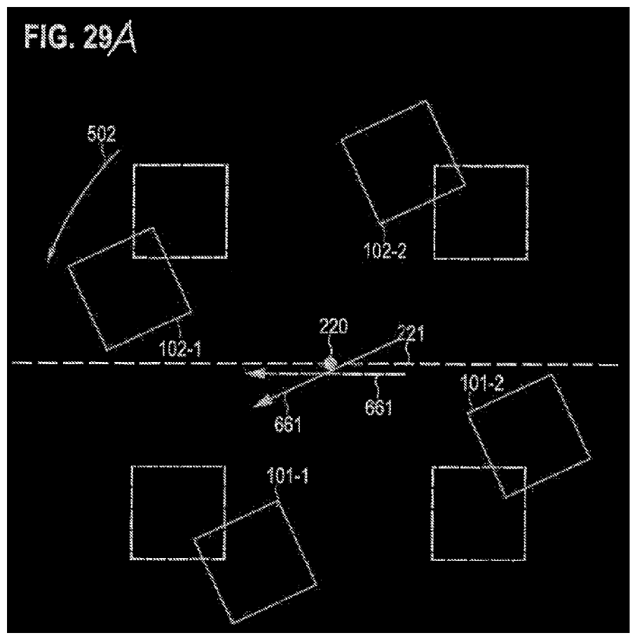

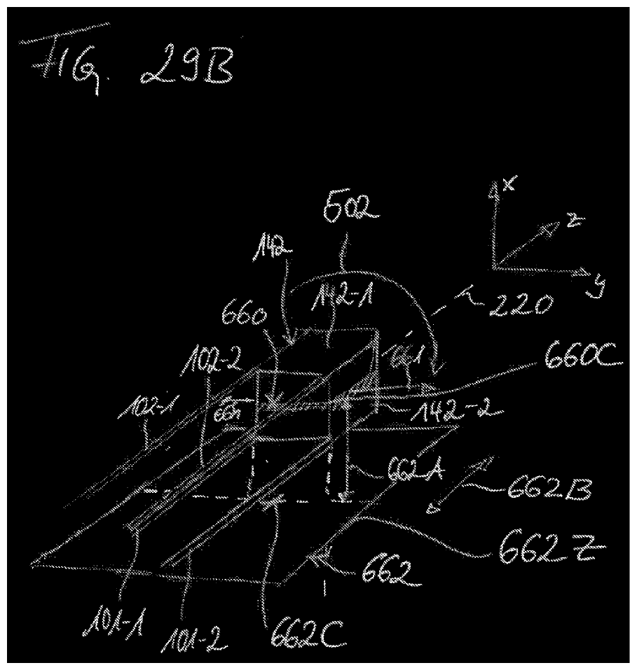

The example from FIG. 28 essentially corresponds to the example from FIG. 1. In the example from FIG. 29A, a magnet 660 is additionally placed on or attached to the interface element 142. In the example from FIG. 28, the magnet 660 is formed as a ferromagnetic coating. In other examples, it would also be possible that the magnet 660 is formed, for example, as bulk material or a ferromagnetic pill.

In the example from FIG. 28, an angular magnetic field sensor 662 is also provided, which is arranged in the stray magnetic field of the magnet 660. The angular magnetic field sensor 662 outputs a signal, which is indicative of the torsion 502 of the scanning module 100. For example, the signal may be analog and have a signal level which varies in a range, for example, of from 0° to 360° between a minimum and a maximum depending on the orientation of the stray magnetic field. A digital signal could also be output, which digitally codes the orientation of the stray magnetic field. The signal can be received, for example, by a controller and used for suitable actuation of the piezo bending actuators 310, 320. For example, a control circuit can be implemented in order to precisely reproduce the superposed FIG. 900.

In general, the signal of the angular magnetic field sensor 662 cannot vary with the strength of the stray magnetic field.

The movement of the torsion 502 can thereby be precisely monitored. The corresponding angle 901, 902, which is implemented by the respective scanning unit 99, can then be precisely deduced. An especially high lateral resolution can thereby be provided for a LIDAR measurement.

In the example from FIG. 28, the back side 152 of the mirror 150 is arranged between the mirror surface 151 and the magnet 660 and the angular magnetic field sensor 162. This means that both the magnet 660 and the angular magnetic field sensor 662 are arranged backwards in relation to the mirror surface 151. This means that both the magnet 660 and the angular magnetic field sensor 662 are arranged on a side of the mirror 150 facing the back side 152. An especially high level of integration can thereby be achieved. In addition, the angular magnetic field sensor 162 can be arranged especially close to the magnet 660 such that a high signal-to-noise ratio can be achieved. The corresponding angle 901, 902 can also be thereby determined especially precisely. In particular, a structural separation between the optical path of the light 180 and the angular magnetic field sensor 662 can be achieved especially simply, because the optical path of the light 180 extends to a side of the mirror 150 facing the front side 151. Because the magnet 660 and the angular magnetic field sensor 662 are arranged backwards in relation to the mirror 150, the distance 70 can be dimensioned especially small with a scanner 90 of multiple scanning units 99.

In the example from FIG. 28, the magnetic moment 661 of the magnet 660 is arranged perpendicular to the central axis 220 and/or or to the torsion axis of the torsion mode 502 (cf. FIG. 29A). In general, the magnet 660 may have a magnetic moment 661, which has at least one component perpendicular to the torsion axis. For example, an in-plane angular magnetic field sensor 662, which has a sensitivity in the drawing plane of FIG. 29A, can thereby be used. In other examples, an angular magnetic field sensor 662 with an out-of-plane sensitivity could also be used.

In the example from FIGS. 28 and 29A, the magnetic moment 661 is furthermore arranged symmetrical to the central axis 220 and/or to the torsion axis of the torsion 502. This means that the magnetic moment 661 has an expansion to both sides of the central axis and/or the torsion axis. Reflection symmetry is not required. However, the angular magnetic field sensor 662 is simultaneously arranged eccentrically in relation to the central axis 220. This can reduce, for example, the measured signal, wherein a more flexible selection is enabled, however, in relation to the attachment of the angular magnetic field sensor 662. For example, the angular magnetic field sensor 662 can be attached radially adjacent the base 141. In other examples, it would also be possible, however, for the angular magnetic field sensor 662 to be arranged adjacent to the magnet 660, i.e. not offset along the central axis 220 with respect to the magnet 660.

The magnet 660 is attached close to the central axis 220. The magnet 660 is particularly attached symmetrically in relation to the central axis 220. This prevents the mass moment of inertia of the moving parts, i.e. of the interface element 142 and of the mirror 150, from increasing excessively due to the provision of the magnetic material. Torsion modes can thereby be achieved with higher natural frequency. Due to the symmetrical arrangement, an asymmetry is prevented which would impact the torsion mode.

In the example from FIG. 28, the magnet 660 is rigidly connected to the mirror 150, i.e. it is arranged in the moved coordinate system; while the angular magnetic field sensor 662 is arranged in the reference coordinate system of the base 141. In this manner, signals of the angular magnetic field sensor 662 can be read out especially simply, because transfer from the moved coordinate system to the reference coordinate system—in which typically the controller is arranged—it is not necessary. In other examples, it would also be possible, however, that a reverse arrangement is provided, i.e. that the angular magnetic field sensor 662 is arranged in the moved coordinate system and the magnet 660 is arranged in the reference coordinate system of the base 141. For example, the signal of the angular magnetic field sensor 662 could then be transferred wirelessly, for example by means of light modulation. Alternatively, electrical conductors—e.g. due to metallic coating or doping—may also be provided along the elastic elements 101, 102, with the conductors enabling a transmission of signals of the angular magnetic field sensor 662. Such an implementation may be helpful, for example, if one and the same magnet 660 is providing a stray magnetic field for multiple angular magnetic field sensors 662, which are associated with different scanning units 99, 99-1, 99-2 of a scanner 90 or are arranged in the moved coordinate systems of different scanning units 99, 99-1, 99-2. The different angular magnetic field sensors 662 may thus be rigidly connected to the deflection units of different scanning units 99, 99-1, 99-2. For example, the magnet 660 may be especially strong such that a large straight magnetic field is available.

In an example according to FIG. 28—in which the magnets 660 are attached in the moved coordinate system—a simple separation of the stray magnetic fields from magnets 660 associated with different scanning units 99-1, 99-2 can take place as follows: with an in-plane sensitivity of the angular magnetic field sensor 662 and a vertical arrangement of the torsion axes 220 (cf. FIG. 16), the angular magnetic field sensors 662 associated with different scanning units 99-1, 99-2 have no cross-sensitivity or only a small amount. This is the case, because the corresponding stray magnetic fields rotate in planes oriented perpendicular to one another.

FIG. 29B illustrates aspects in relation to an arrangement of the magnet 660 in relation to the angular magnetic field sensor 662. The example from FIG. 29B substantially corresponds to the example from FIG. 15 (in FIG. 29B, the mirror 150 is not shown for the sake of clarity; however, the perspective from FIG. 29 corresponds to the perspective from FIG. 15, in which the mirror 150 is also shown).

The magnet 660 is attached to the interface element 142. In particular, the magnet 660 is embedded in the interface element 142. This can be achieved, for example, in that a two-part interface element 142-1, 142-2 is used, for example according to FIG. 15. The magnet 660 can then be provided as a spacer between the contact surfaces 160 of the two interface elements 142-1, 142-2.

In FIG. 29B, the elastic elements extend along the z-axis. The torsion axis and/or the central axis 220 is thus parallel to the z-axis. The magnetization 661 of the magnet 660 is oriented perpendicular to the z-axis, along the y-axis. The magnetization 661 is arranged symmetrically with respect to the torsion axis and/or the central axis 220.

The angular magnetic field sensor 662 is arranged eccentrically with respect to the central axis 220, namely offset along the x-axis in the example from FIG. 29B (in general, the angular magnetic field sensor 662 could also be arranged offset along the y-axis). A corresponding distance 662A between the magnet 660 and a sensitive surface 662Z of the angular magnetic field sensor 662 is shown in FIG. 29B.

The angular magnetic field sensor 662 has the sensitive surface 662Z. This extends in the yz-plane. The angular magnetic field sensor 662 has an in-plane sensitivity; therefore, the angular magnetic field sensor 662 outputs a signal, which is indicative of the orientation of the stray magnetic field of magnetization 661 in the yz-plane. The strength of the stray magnetic field does not penetrate the signal.

The angular magnetic field sensor 662 is arranged opposite the magnet 660, offset along the z-axis; the corresponding distance 662B is shown schematically (e.g., the distance 662B could be defined in relation to a center of the magnet 660 along the z-axis). In the example from FIG. 29B, the center 662C of the sensitive surface 662Z of the angular magnetic field sensor 662 is aligned on an edge 660C of the magnet 660 facing the base 141, i.e. at the transition between the elastic elements 101-1, 101-2, 102-1, 102-2 and the interface element 142 (indicated by the dashed line oriented in the x-direction in FIG. 29B). The offset 662B means that the stray magnetic field rotates in the sensitive surface 662Z in the yz-plane when the magnet according to the torsion 502 is distorted. Nonlinear associations between the torsion 502 and the angle of the stray magnetic field are prevented by the offset 662B, limited in size.

The sensitivity of the angular magnetic field sensor 662 in relation to a movement of the base 142 is discussed in the following. Without torsion of the base 141, i.e. in the standby state, the magnetization 661 is aligned along the y-axis (as shown in FIG. 29B). The stray magnetic field is then also oriented in the sensitive surface 662Z along the y-axis. When a torsion 502 distorts the base 142, the magnetization 661 also distorts. For example, a torsion angle of 90° C. would correspond to an orientation of the magnetization 661 along the negative x-axis. The eccentric arrangement of the angular magnetic field sensor 662 thereby results in an effective orientation of the stray magnetic field along the z-direction. This distortion of the stray magnetic field in the sensitive surface 662Z is measured by the angular magnetic field sensor 662.

With a transverse deflection of the base 142 along the x-axis, the orientation of the stray magnetic field does not change especially strongly in the sensitive plane 662Z. Therefore, the measuring signal is not significantly distorted. A transverse deflection of the base 142 along the y-axis changes the orientation of the stray magnetic field in the sensitive plane 662Z even more strongly than the deflection along the x-axis. In order to compensate for this effect, it would be possible to provide two angular magnetic field sensors, which are arranged reflected in relation to the central axis 220 (not shown in FIG. 29B); thus, the two angular magnetic field sensors may have the same distance 662A to the magnet 660, but once along the positive x-axis and once along the negative x-axis. Distance 662B can be the same. The angular magnetic field sensors may thus be arranged in order to output corresponding signals in relation to the torsion 502—that is, for example, the same or, for example, positively correlated—and to output complementary signals in relation to the transverse deflection. A transverse deflection of the base 142 along the y-axis results in opposite contributions to the signal of the two angular magnetic field sensors. The transverse deflection can be quantified using subtraction. The control can thereby consider, e.g. damp, transverse deflections as well—in addition to the torsion 502. This means that a corresponding control circuit specifies a setpoint amplitude of the transverse deflection of essentially zero.

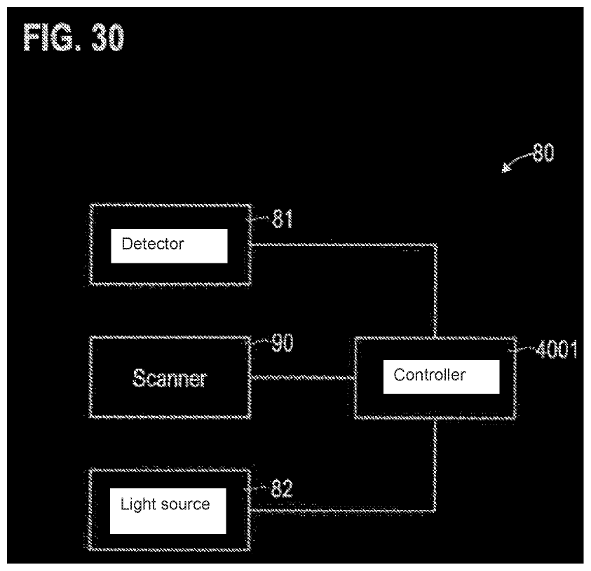

FIG. 30 illustrates aspects in relation to a LIDAR system 80. The LIDAR system 80 comprises a laser scanner 90, which may be formed, for example, according to the various implementations described herein. The LIDAR system also comprises a light source 81. For example, the light source 81 could also be formed as a laser diode, which emits pulsed laser light 180 in the near infrared range with a pulse length in a range of nanoseconds.

The light 180 of the light source 81 can strike then on one or more mirror surfaces 151 of the scanner 90. Depending on the orientation of the deflection unit, the light is deflected at different angles 901, 902. The light emitted by the light source 81 and deflected by the mirror surface of the scanner 90 is often also call the primary light.

The primary light can then strike an environmental object of the LIDAR system 80. The primary light reflected in this manner is characterized as secondary light. The secondary light may be detected by a detector 82 of the LIDAR system 80. Based on a travel time, which can be determined as a time delay between the emitting of the primary light by the light source 81 and the detecting of the secondary light by the detector 82, a distance between the light source 81 or the detector 82 and the environmental object can be determined by means of a controller 4001.

In some cases, the emitter aperture can be the same as the detector aperture. This means that the same scanner can be used to scan the detector aperture. For example, the same mirrors can be used in order to emit primary light and to detect secondary light. A beam splitter can then be provided to split primary and secondary light. Such techniques may make it possible to achieve an especially high level of sensitivity. This is the case, because the detector aperture can be aligned and limited in the direction in which the secondary light arrives. Ambient light is reduced by space filtering, because the detector aperture can be dimensioned smaller.

In addition to this distance measurement, a lateral position of the environmental object can also be determined, for example, by the controller 4001. This can occur by means of monitoring the position and/or orientation of the one or more deflection units of the laser scanner 99. In doing so, the position and/or orientation of one or more deflection units in the moment the light 180 strikes may correspond to a deflection angle 901, 902; the lateral position of the environmental object can be deduced therefrom. For example, it may be possible to determine the position and/orientation of the deflection unit based on a signal of the angular magnetic field sensor 662.

Because the signal of the angular magnetic field sensor 662 is considered when determining the lateral position of the environmental objects, it may be possible to determine the lateral position of the environmental objects with especially great accuracy. Particularly in comparison with techniques which only consider a driver signal for the actuation of actuators of the movement when determining the lateral position of the environmental objects, an increased accuracy can be achieved in this manner.

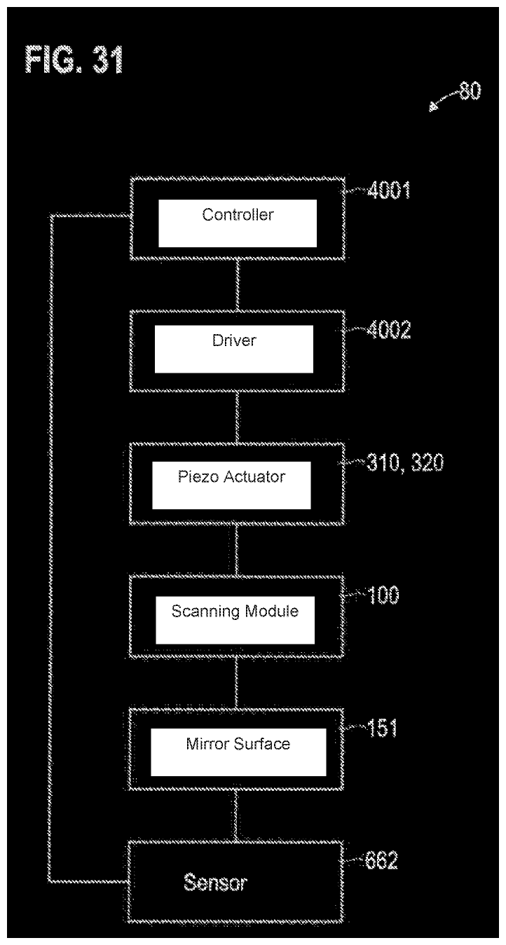

FIG. 31 illustrates aspects in relation to a LIDAR system 80. The LIDAR system 80 comprises a controller 4001, which could be implemented, for example, as a microprocessor or application-specific integrated circuit (ASIC). The controller 4001 could also be implemented as a field-programmable gate array (FPGA). The controller 4001 is set up to output control signals to a driver 4002. For example, the control signals could be output in digital or analog form.

The driver 4002 is set up, in turn, to generate one or more voltage signals and to output them to corresponding electrical contacts of the piezo actuators 310, 320. Typical amplitudes of the voltage signals are in a range of from 50 V to 250 V.

The piezo actuators 310, 320 are then coupled with the scanning module 100 such as described, for example, in the previous reference to FIGS. 5 and 6. One or more degrees of freedom of movement of the scanning module 100, particularly one or more support elements 101, 102 of the scanning module 100, can thereby be excited. The deflection unit is thereby deflected. The environmental region of the laser scanner 99 can thereby be scanned with light 180. In particular, the torsion mode 502 can be excited.

The controller 4001 can be set up to suitably excite the piezo actuators 310, 320 in order to implement a superposed figure for scanning a 2D environmental region. To this end, techniques related to the amplitude modulation function 842 can be implemented. In the example from FIG. 31, the controller 4001 may be particularly set up in order to actuate the driver 4002 and/or the piezo bending actuators 310, 320 according to the actuator movements 831 of the examples from FIGS. 23 and 25. The superposed FIG. 900 can then be implemented.

FIG. 31 further shows that there is a coupling between the controller 4001 and the angular magnetic field sensor 662. The controller 4001 can be set up in order to actuate the one or more piezo actuators 310, 320 based on the signal of the angular magnetic field sensor 662. Monitoring of the movement of the mirror surface 151 by the controller 4001 can occur by means of such techniques. If necessary, the controller 4001 can adapt the actuation of the driver 4002 in order to reduce deviations between a desired movement of the mirror surface 151 and an observed movement of the mirror surface 151.

For example, it would be possible that a closed-loop control is implemented. For example, the closed-loop control may comprise the setpoint amplitude of the movement as a control variable. For example, the closed-loop control may comprise the actual amplitude of the movement as a control variable. In doing so, the actual amplitude of the movement could be based on the signal of the angular magnetic field sensor 662.

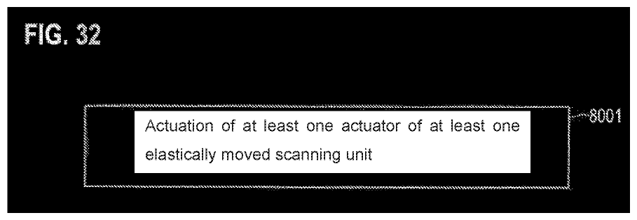

FIG. 32 is a flowchart of an exemplary method. In 8001, an actuator, for example a piezo bending actuator, is actuated to excite a first degree of freedom of movement of an elastically moved scanning unit according to a periodic amplitude modulation function. In this process, the periodic amplitude modulation function has alternately arranged ascending flanks and descending flanks. A length of the ascending flanks, in this case, may be at least double the size of a length of the descending flanks, optionally at least four times the size, further optionally at least 10 times the size.

Obviously, the features of the previously described embodiments and aspects of the invention can be combined with one another. In particular, the features cannot only be used in the described combinations but also in other combinations or in isolation without extending beyond the scope of the invention.

For example, techniques have been described previously in which a superimposed figure is implemented with short descending flanks and long ascending flanks. Accordingly, it would also be possible, for example, that comparatively long descending flanks and comparatively short ascending flanks are used; in one such example, it could be possible, for example, that the LIDAR imaging essentially takes place during the comparatively long descending flanks. In some cases, it would also be possible that equally long ascending and descending flanks are used; in such cases, efficient scanning can also be ensured by means of a suitable implementation of the superposed figure, for example without or with a few nodes.

Furthermore, techniqueshave been described previously in which two time-overlapping degrees of freedom of movement are excited with the same frequency. In some cases, it would also be possible, for example, that a first degree of freedom of movement is excited with a first frequency and a second degree of freedom of movement is excited with a second frequency, which is different from the first frequency, for example by a factor of 2. A superposed figure may thereby have a node, for example, which can reduce the efficiency of the scanning of the environmental region but can simultaneously make the selection of the degrees of freedom of movement more flexible.

Furthermore, various examples have been described previously relating to a superposed figure, which is described by means of a temporal superposition of a first torsion mode, which is associated with a first scanning unit, and a second torsion mode, which is associated with a second scanning unit. Corresponding techniques, however, may also be implemented when, for example, two transverse modes are used, which are associated with different scanning units.

Furthermore, various techniques in relation to the movement of scanning units associated with LIDAR measurements have been described previously. Corresponding techniques may also be used, however, in other applications, e.g. for projectors or laser scanning microscopes etc.

1. A scanner, comprising:
a scanning unit comprising an elastic element, which extends between a base and a deflection unit, wherein the scanning unit is configured to deflect light at the deflection unit at different angles by means of torsion of the elastic element,
a magnet configured to generate a stray magnetic field, and
an angular magnetic field sensor positioned in the stray magnetic field and configured to output a signal indicative of the torsion of the elastic element,
wherein a magnetic moment of the magnet has a component, which is oriented perpendicular to a torsion axis of the torsion of the elastic element.

2. The scanner according to claim 1, further comprising:
an interface element formed integrally with the elastic element and configured to secure the deflection unit,
wherein the magnet is placed on or embedded in the interface element.

3. The scanner according to claim 2,
wherein the scanning unit comprises two pairs of support elements, wherein each pair of support elements is assigned to a corresponding interface element,
wherein the interface elements assigned to the two pairs of support elements are connected to one another via the magnet.

4. The scanner according to claim 1,
wherein the deflection unit comprises a mirror with a mirror surface, configured to deflect the light, and a back side opposite the mirror surface,
wherein the back side is arranged between the mirror surface and at least one of the magnet and the angular magnetic field sensor.

5. The scanner according to claim 4,
wherein the elastic element comprises a rod and extends from a side facing away from the mirror surface to the base of the scanning unit,
wherein a length of the rod is no less than 20% of a diameter of the mirror.

6. The scanner according to claim 4,
wherein the magnet comprises a ferromagnetic coating or comprises a ferromagnetic pill.

7. The scanner according to claim 1,
wherein a magnetic moment of the magnet is symmetrical to the torsion axis of the torsion of the elastic element.

8. The scanner according to claim 1,
wherein the angular magnetic field sensor has an in-plane sensitivity.

9. The scanner according to claim 1,
wherein the angular magnetic field sensor is arranged eccentrically with respect to the torsion axis of the torsion of the elastic element.

10. The scanner according to claim 1,
wherein the magnet is rigidly connected to the deflection unit and the angular magnetic field sensor is rigidly connected to the base, or
wherein the magnet is rigidly connected to the base and the angular magnetic field sensor is rigidly connected to the deflection unit.

11. The scanner according to claim 1, further comprising:
a further scanning unit comprising a further elastic element, which extends between the base or a further base and a further deflection unit, wherein the further scanning unit is configured to deflect light at the deflection unit at different angles by means of a further torsion of the further elastic element,
a further magnet configured to generate a further stray magnetic field, and
a further angular magnetic field sensor positioned in the further stray magnetic field and configured to output a further signal indicative of the further torsion of the further elastic element.

12. The scanner according to claim 11,
wherein a magnetic moment (661) of the magnet forms an angle of 90°±10° with the torsion axis of the torsion of the elastic element and rotates in a first plane during the torsion of the elastic element,
wherein a magnetic moment (661) of the further magnet forms an angle of 90°±10° with a torsion axis of the further torsion of the further elastic element and rotates in a second plane during the further torsion of the further elastic element,
wherein the first plane and the second plane form an angle of 90°±10° with one another.

13. The scanner according to claim 1, further comprising:
a further scanning unit comprising a further elastic element, which extends between the base or a further base and a further deflection unit, wherein the further scanning unit is configured to deflect light at the deflection unit at different angles by means of a further torsion of the further elastic element,
a further angular magnetic field sensor positioned in the stray magnetic field and configured to output a further signal indicative of the further torsion of the further elastic element,
wherein the magnet is rigidly connected to the base and the angular magnetic field sensor is rigidly connected to the deflection unit and the further angular magnetic field sensor is rigidly connected to the further deflection unit.

14. The scanner according to claim 1,
wherein the angular magnetic field sensor is configured to output a signal indicative of an orientation of the stray magnetic field.

15. The scanner according to claim 1, further comprising:
at least one actuator configured to excite the torsion by means of resonant excitation of a torsion mode and according to a periodic amplitude modulation function, which has alternately arranged ascending and descending flanks.

16. The scanner according to claim 1,
wherein a center of a sensitive surface of the angular magnetic field sensor is arranged offset with respect to the magnet by a distance 662B along the torsion axis of the elastic element.

17. The scanner according to claim 1,
wherein a center of a sensitive surface of the angular magnetic field sensor is aligned on an edge of the magnet facing the base.

18. The scanner according to claim 1, further comprising:
a controller configured to implement a closed-loop control, which comprises an actual amplitude of a movement as a control variable, wherein the actual amplitude of the movement is determined based on the signal of the angular magnetic field sensor.

19. The scanner according to claim 1, further comprising:
a further angular magnetic field sensor,
wherein the angular magnetic field sensor and the further angular magnetic field sensor are configured to output corresponding signals in relation to the torsion and configured to output complementary signals in relation to a transverse deflection of the elastic element.

20. The scanner according to claims 18, further comprising:
a further angular magnetic field sensor,
wherein the angular magnetic field sensor and the further angular magnetic field sensor are configured to output corresponding signals in relation to the torsion and configured to output complementary signals in relation to a transverse deflection of the elastic element,
wherein the controller is configured to determine the transverse deflection by means of subtraction of the signals of the angular magnetic field sensor and of the further angular magnetic field sensor,
wherein the closed-loop control optionally stipulates a setpoint amplitude of the transverse deflection of zero.
